(19) United States
(12) Patent Application Publication
(10) Pub. No.: US 2026/0143499 A1
(43) Pub. Date: May 21, 2026

(54) METHOD AND APPARATUS FOR RECEIVING COMMON PDCCH, METHOD AND APPARATUS FOR SENDING COMMON PDCCH, AND DEVICE

(71) Applicant: VIVO MOBILE COMMUNICATION CO., LTD., Guangdong (CN)

(72) Inventors: Wei JIANG, Guangdong (CN); Zhipeng LIN, Guangdong (CN); Yong WANG, Guangdong (CN)

(73) Assignee: VIVO MOBILE COMMUNICATION CO., LTD., Guangdong (CN)

(21) Appl. No.: 19/451,986

(22) Filed: Jan. 16, 2026

Related U.S. Application Data
(63) Continuation of application No. PCT/CN2024/104841, filed on Jul. 11, 2024.

(30) Foreign Application Priority Data
Jul. 18, 2023 (CN) 202310882187.1

(51) Int. Cl. H04W 72/23; H04W 74/0833

(52) U.S. Cl. CPC H04W 72/23; H04W 74/0833

(57) ABSTRACT

A method and an apparatus for receiving a common PDCCH, a method and an apparatus for sending a common PDCCH, and a device. The method for receiving a common PDCCH in embodiments of this application includes: A terminal determines a transmission resource or a transmission characteristic of a common PDCCH repetition transmission. The terminal receives the common PDCCH repetition transmission based on the transmission resource or the transmission characteristic, where the common PDCCH includes at least one of the following: a SIB1 PDCCH, an other system information OSI PDCCH, a message 2 PDCCH, a message 4 PDCCH, a message B PDCCH, a paging PDCCH, and a PDCCH for scheduling a retransmission of a message 3.

### CROSS-REFERENCE TO RELATED APPLICATIONS

This application is a continuation application of PCT International Application No. PCT/CN 2024/104841 filed on Jul. 11, 2024, which claims priority to Chinese Patent Application No. 202310882187.1, filed on Jul. 18, 2023, which is incorporated herein by reference in its entirety.

### TECHNICAL FIELD

This application relates to the field of communications technologies, and specifically, to a method and an apparatus for receiving a common physical downlink control channel (PDCCH), a method and an apparatus for sending a common PDCCH, and a device.

### BACKGROUND

In a case of terrestrial network scenarios, because a transmit power of a base station is much higher than a transmit power of a terminal, link quality of a downlink channel is usually better than link quality of an uplink channel. However, in some application scenarios, for example, in a non-terrestrial communication network like satellite communication, a downlink transmit power depends on a quantity of beams that are supported by a satellite simultaneously. As the quantity of beams increases, a transmit power corresponding to each beam decreases. For another example, in a high-frequency case, a transmit power of a base station is close to a transmit power of a mobile phone. In this case, quality of the downlink channel is not necessarily better than quality of the uplink channel. In addition, the terminal (User Equipment, UE) sends scheduling information for some common messages using a common physical downlink control channel (Common PDCCH) before a radio resource control (RRC) connection is established. In a case that receiving performance of the common PDCCH is affected due to quality of the downlink channel, the common message scheduled by the common PDCCH fails to be received, and network coverage performance is affected.

### SUMMARY

Embodiments of this application provide a method and an apparatus for receiving a common PDCCH, a method and an apparatus for sending a common PDCCH, and a device.

According to a first aspect, a method for receiving a common PDCCH is provided, including:
A terminal determines a transmission resource or a transmission characteristic of a common PDCCH repetition transmission.

The terminal receives the common PDCCH repetition transmission based on the transmission resource or the transmission characteristic, where
the common PDCCH includes at least one of the following:
a system information block SIB1 PDCCH, an other system information OSI PDCCH, a message 2 PDCCH, a message 4 PDCCH, a message B PDCCH, a paging PDCCH, and a PDCCH for scheduling a retransmission of a message 3.

According to a second aspect, a method for sending a common PDCCH is provided, including:
A network side device determines a transmission resource or a transmission characteristic of a common PDCCH repetition transmission.

The network side device performs the common PDCCH repetition transmission based on the transmission resource or the transmission characteristic, where
the common PDCCH includes at least one of the following:
a system information block (SIB) 1 PDCCH, an other system information (OSI) PDCCH, a message 2 PDCCH, a message 4 PDCCH, a message B PDCCH, a paging PDCCH, and a PDCCH for scheduling a retransmission of a message 3.

According to a third aspect, an apparatus for receiving a common PDCCH is provided, including:
a determining module, configured to determine a transmission resource or a transmission characteristic of a common PDCCH repetition transmission; and
a receiving module, configured to receive the common PDCCH repetition transmission based on the transmission resource or the transmission characteristic, where
the common PDCCH includes at least one of the following:
a system information block SIB1 PDCCH, an other system information OSI PDCCH, a message 2 PDCCH, a message 4 PDCCH, a message B PDCCH, a paging PDCCH, and a PDCCH for scheduling a retransmission of a message 3.

According to a fourth aspect, an apparatus for sending a common PDCCH is provided, including:
a determining module, configured to determine a transmission resource or a transmission characteristic of a common PDCCH repetition transmission; and
a performing module, configured to perform the common PDCCH repetition transmission based on the transmission resource or the transmission characteristic, where
the common PDCCH includes at least one of the following:
a system information block SIB1 PDCCH, an other system information OSI PDCCH, a message 2 PDCCH, a message 4 PDCCH, a message B PDCCH, a paging PDCCH, and a PDCCH for scheduling a retransmission of a message 3.

According to a fifth aspect, a terminal is provided. The terminal includes a processor and a memory, the memory stores a program or an instruction that is executable on the processor, and the program or the instruction is executed by the processor to implement the steps of the method for receiving a common PDCCH provided in the embodiments of this application.

According to a sixth aspect, a terminal is provided, and includes a processor and a communication interface. The processor is configured to determine a transmission resource or a transmission characteristic of a common PDCCH repetition transmission. The communication interface is configured to receive the common PDCCH repetition transmission based on the transmission resource or the transmission characteristic, where the common PDCCH includes at least one of the following: a system information block SIB1 PDCCH, an other system information OSI PDCCH, a message 2 PDCCH, a message 4 PDCCH, a message B PDCCH, a paging PDCCH, and a PDCCH for scheduling a retransmission of a message 3.

According to a seventh aspect, a network side device is provided. The network side device includes a processor and a memory, the memory stores a program or an instruction that is executable on the processor, and the program or the instruction is executed by the processor to implement the steps of the method for sending a common PDCCH provided in the embodiments of this application.

According to an eighth aspect, a network side device is provided, and includes a processor and a communication interface. The processor is configured to determine a transmission resource or a transmission characteristic of a common PDCCH repetition transmission. The communication interface is configured to perform the common PDCCH repetition transmission based on the transmission resource or the transmission characteristic, where the common PDCCH includes at least one of the following: a system information block SIB1 PDCCH, an other system information OSI PDCCH, a message 2 PDCCH, a message 4 PDCCH, a message B PDCCH, a paging PDCCH, and a PDCCH for scheduling a retransmission of a message 3.

According to a ninth aspect, a readable storage medium is provided. The readable storage medium stores a program or an instruction, and the program or the instruction is executed by a processor to implement the steps of the method for receiving a common PDCCH provided in the embodiments of this application, or implement the steps of the method for sending a common PDCCH provided in the embodiments of this application.

According to a tenth aspect, a wireless communication system is provided, including a terminal and a network side device. The terminal may be configured to perform the steps of the method for receiving a common PDCCH provided in the embodiments of this application, and the network side device may be configured to perform the steps of the method for sending a common PDCCH provided in the embodiments of this application.

According to an eleventh aspect, a chip is provided. The chip includes a processor and a communication interface, the communication interface is coupled to the processor, and the processor is configured to run a program or an instruction to implement the method for receiving a common PDCCH provided in the embodiments of this application, or implement the method for sending a common PDCCH provided in the embodiments of this application.

According to a twelfth aspect, a computer program/program product is provided. The computer program/program product is stored in a storage medium, and the program/program product is executed by at least one processor to implement the steps of the method for receiving a common PDCCH provided in the embodiments of this application, or the program/program product is executed by at least one processor to implement the steps of the method for sending a common PDCCH provided in the embodiments of this application.

### BRIEF DESCRIPTION OF DRAWINGS

FIG. 1 is a block diagram of a wireless communication system to which embodiments of this application are applicable;

FIG. 2 is a flowchart of a method for receiving a common PDCCH according to an embodiment of this application;

FIG. 3 is a flowchart of a method for sending a common PDCCH according to an embodiment of this application;

FIG. 4 is a structural diagram of an apparatus for receiving a common PDCCH according to an embodiment of this application;

FIG. 5 is a structural diagram of an apparatus for sending a common PDCCH according to an embodiment of this application;

FIG. 6 is a structural diagram of a communication device according to an embodiment of this application;

FIG. 7 is a structural diagram of a terminal according to an embodiment of this application; and

FIG. 8 is a structural diagram of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

Terms such as “first” and “second” in this application are used to distinguish between similar objects, and are not used to describe a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, “or” in this application means at least one of the connected objects. For example, “A or B” includes three solutions, namely: solution 1: include A but exclude B; solution 2: include B but exclude A; solution 3: include both A and B. The character “/” usually indicates an “or” relationship between the associated objects.

The term “indication” in this application may be a direct indication (or explicit indication) or an indirect indication (or implicit indication). The direct indication may be understood as that a sender explicitly notifies a sent indication of content such as specific information, an operation that needs to be performed, or a request result to a receiver. The indirect indication may be understood as that the receiver determines corresponding information according to the indication sent by the sender, or performs determining according to the indication sent by the sender, and determines, according to a determining result, the operation that needs to be performed, the request result, or the like.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), single-carrier frequency-division multiple access (SC-FDMA), or other systems. The terms “system” and “network” in the embodiments of this application may be used interchangeably. The technologies described can be applied to both the systems and the radio technologies mentioned above as well as to other systems and radio technologies. A new radio (NR) system is described in the following descriptions for illustrative purposes, and the NR terminology is used in most of the following descriptions, although these technologies can also be applied to a system other than the NR system, such as a 6 generation (6G) communication system.

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer, a laptop computer, a notebook computer, a personal digital assistant (PDA), a palmtop computer, a netbook, an ultra-mobile personal computer (UMPC), a mobile Internet device (MID), an augmented reality (AR) device, a virtual reality (VR) device, a robot, a wearable device, a flight vehicle, vehicle user equipment (VUE), ship user equipment, pedestrian user equipment (PUE), a smart home device (a home device with a wireless communication function, such as a refrigerator, a television, a washing machine, or a furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart chain, and the like), a smart wrist strap, a smart dress, and the like. The vehicle user equipment may also be referred to as a vehicle terminal, a vehicle controller, a vehicle module, a vehicle component, a vehicle chip, a vehicle unit, or the like. It should be noted that a specific type of the terminal 11 is not limited in the embodiments of this application. The network side device 12 may include an access network device or a core network device. The access network device may also be referred to as a radio access network (RAN) device, a radio access network function, or a radio access network unit. The access network device may include a base station, a wireless local area network (WLAN) access point (AP), wireless fidelity (WiFi) node, or the like. The base station may be referred to as a NodeB (NB), an evolved NodeB (eNB), a next generation NodeB (gNB), a new radio NodeB (NR NodeB), an access point, a relay base station (RBS), a serving base station (SBS), a base transceiver station (BTS), a radio base station, a radio transceiver, a basic service set (BSS), an extended service set (ESS), a home NodeB (HNB), a home evolved NodeB, a transmission reception point (TRP), or another appropriate term in the field. Provided that a same technical effect is achieved, the base station is not limited to a specified technical term. It should be noted that, in the embodiments of this application, only a base station in an NR system is used as an example for description, and a specific type of the base station is not limited.

The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF), an edge application server discovery function (EASDF), a unified data management (UDM), a unified data repository (UDR), a home subscriber server (HSS), a centralized network configuration (CNC), a network repository function (NRF), a network exposure function (NEF), a local NEF (L-NEF), a binding support function (BSF), an application function (AF), and the like. It should be noted that, in the embodiments of this application, only a core network device in an NR system is used as an example for description, and a specific type of the core network device is not limited.

In some embodiments, a random access procedure may be a contention-based random access procedure or a non-contention-based random access procedure. The random access procedure may be a 4-step random access procedure (also referred to as a Type-1 random access procedure) or a 2-step random access procedure (also referred to as a Type-2 random access procedure).

In the contention-based 4-step random access procedure (RACH), a terminal first sends message 1 (Msg 1 ) to a network, including a preamble; after detecting the preamble, the network sends a message 2 (Msg2)/random access response (RAR) message, including a number of the preamble detected by the network and an uplink radio resource allocated to the terminal to send a message 3 (Msg3); after receiving the Msg2, the terminal confirms that at least one of preamble numbers carried in the Msg2 is consistent with the number of the preamble sent by the terminal, and then sends, according to a resource indicated by the RAR, the Msg3 including contention resolution information; after receiving the Msg3, the network sends a message 4 (Msg4) including contention resolution information; and after receiving the Msg4, the terminal confirms that the contention resolution information is consistent with the contention resolution information sent by the terminal in the Msg3. Therefore, 4-step random access is completed.

The network includes uplink grant (UL grant) information in the RAR to indicate scheduling information for a Msg3 physical uplink shared channel (PUSCH), and includes a random access preamble identifier (RACH preamble ID, RAPID), a temporary-radio network temporary identifier (temporary cell-radio network temporary identifier, TC-RNTI), a timing advance (TA), and other information. In a case that the network does not receive the Msg3 PUSCH, the network may schedule a retransmission of the Msg3 PUSCH in a physical downlink control channel (PDCCH) scrambled by the TC-RNTI.

For the contention-based random access procedure, different terminals randomly select preambles for transmission. As a result, different terminals may select a same preamble for sending on a same time-frequency radio resource (such as a random access occasion (RACH Occasion, RO) resource). This case may be understood as a preamble collision of the terminals. In this case, different terminals receive a same RAR. At this time, different terminals transmit Msg3 PUSCH according to scheduling information in the UL grant of the RAR. In some related technologies, a repetition transmission of the Msg3 PUSCH is not supported, and the network can decode, on one Msg3 PUSCH scheduling resource, only a PUSCH (including contention resolution information) sent by one terminal. Therefore, the network includes, in the Msg4, the contention resolution information received in the Msg3. In a case that the contention resolution information in the Msg4 received by the terminal matches the contention resolution information sent by the terminal in the Msg3 PUSCH, the terminal considers that contention resolution succeeds. In a case that the contention resolution information in the Msg4 received by the terminal does not match the contention resolution information sent by the terminal in the Msg3 PUSCH, the terminal considers that contention resolution fails.

In a case that contention resolution fails, the terminal re-selects a RACH sending resource and sends the physical random access channel (PRACH) to attempt random access again.

In some embodiments, a first step of the 2-step random access procedure (2-step RACH) is that a terminal sends a message A (MsgA) to a network side. After receiving the MsgA, the network side sends a message B (MsgB) to the terminal. In a case that the terminal does not receive the MsgB within a period of time, the terminal increases a counter by 1 for counting a quantity of times of sending the MsgA and re-sends the MsgA. In a case that the counter for counting the quantity of times of sending the MsgA reaches a specific threshold, the terminal switches from the 2-step random access procedure to the 4-step random access procedure. The MsgA includes a MsgA preamble part and a MsgA PUSCH part. The preamble part is sent on an RO used in the 2-step random access procedure, and the PUSCH part is sent on MsgA PUSCH resources, for sending the MsgA preamble, associated with the RO. The MsgA PUSCH resources refer to a group of PUSCH resources configured for each PRACH slot, including a time-frequency resource and a DMRS resource.

In some embodiments, a CORESET is a set of time-domain and frequency-domain resources for control information. A CORESET #0 is a special CORESET, and is usually used for a transmission of a PDCCH for scheduling a system information block (SIB) 1. Configuration information for the CORESET #0 and configuration information for a monitoring occasion of a Type0-PDCCH common search space (CSS) are carried in an associated cell defining synchronization signal block (CD-SSB). A main function of the CORESET #0 is to define time and frequency resources of the Type0-PDCCH CSS and a size of the monitoring occasion of the Type0-PDCCH CSS.

In some embodiments, the CORESET #0 and a synchronization signal block (SSB) have the following multiplexing modes:

Multiplexing mode 1: is a multiplexing mode in which the SSB and the CORESET #0 appear at different moments (without overlap in time domain), and a transmission bandwidth of the SSB and an initial active downlink bandwidth part (BWP) of the CORESET #0 overlap (with overlap in frequency domain). This may be used for cases with a carrier frequency less than 6 GHz and a carrier frequency greater than 6 GHz (and less than 52.6 GHz).

Multiplexing mode 2: is a multiplexing mode in which the SSB and the CORESET #0 appear at different moments (with no overlap in time domain), and a transmission bandwidth of the SSB and an initial active downlink BWP of the CORESET #0 do not overlap (without overlap in frequency domain); and the SSB is located at the top or bottom of the CORESET #0. This is used for only a case with a carrier frequency greater than 6 GHz. The SSB is located at the top of the CORESET #0, with an interval of 12+k_{SSB} subcarriers. The SSB is located at the bottom of the CORESET #0. In a case that k_{SSB} is equal to 0, an interval is 12 subcarriers. In a case that k_{SSB} is not equal to 0, an interval is 24—kSSB subcarriers.

Multiplexing mode 3: is a multiplexing mode in which the SSB and the CORESET #0 appear at a same moment (with overlap in time domain), and a transmission bandwidth of the SSB and an initial active downlink BWP of the CORESET #0 do not overlap (without overlap in frequency domain); and the SSB is located at the top or bottom of the CORESET #0. This is used for only a case with a carrier frequency greater than 6 GHz. The SSB is located at the top of the CORESET #0, with an interval of kSSB subcarriers. The SSB is located at the bottom of the CORESET #0. In a case that kSSB is equal to 0, an interval is 0 subcarriers. In a case that k_{SSB} is not equal to 0, an interval is 12—k_{SSB} subcarriers.

In some embodiments, there are two types of search space (SS) sets: one is a common search space (common SS, CSS) set that is jointly monitored by a group of terminals in a cell, and the other is a user-specific search space (UE-specific search space, USS) set that is monitored by a single terminal. The SS set further configures, for the terminal, PDCCH candidates that need to be monitored (monitoring) by the terminal. There may be the following several types of search spaces:
1. Type 0-PDCCH common search space set (CSS set): The search space set is used to monitor a SIB1 system message.
2. Type0A-PDCCH CSS set: The search space set is used to monitor a system message other than the SIB1.
3. Type1-PDCCH CSS set: The search space set is used to monitor a downlink PDCCH corresponding to a Msg2/Msg4 in the conventional 4-step random procedure, and a downlink PDCCH corresponding to a MsgB in the 2-step random access procedure.
4. Type2-PDCCH CSS set: The search space set is used to monitor a paging message.
5. Type3-PDCCH CSS set: The search space set is used to monitor an uplink power control PDCCH, a downlink pre-emption PDCCH, a slot format indication PDCCH, and a PDCCH related to a downlink data transmission.
6. USS: The search space set is used to monitor a PDCCH related to a downlink data transmission.

In some embodiments, in the random access procedure, receiving of scheduling information for scheduling a Msg2/MsgB/Msg4 physical downlink shared channel (PDSCH) needs to be within a specific window, and a size of the window is configured by the network.

For the Msg 2, the window starts from a 1^{st} symbol of a 1^{st} control resource set (CORESET) in the Type1-PDCCH common search space set (Type1-PDCCH CSS set) after PRACH sending. For the MsgB, the window starts from a 1^{st} symbol of a 1^{st} CORESET in the Type1-PDCCH CSS set after a PUSCH (MsgA PUSCH part) resource corresponding to PRACH (MsgA PRACH part) sending.

For the Msg4, the window is actually controlled by a random access contention resolution timer (ra-ContentionResolutionTimer). The timer is started or restarted after the Msg3 (in a case that a repetition transmission of the Msg3 is supported, which is a last transmission for sending the Msg3) is sent.

With reference to the accompanying drawings, the following describes in detail a method and an apparatus for receiving a common PDCCH, a method and an apparatus for sending a common PDCCH, and a device provided in the embodiments of this application by using some embodiments and application scenarios thereof.

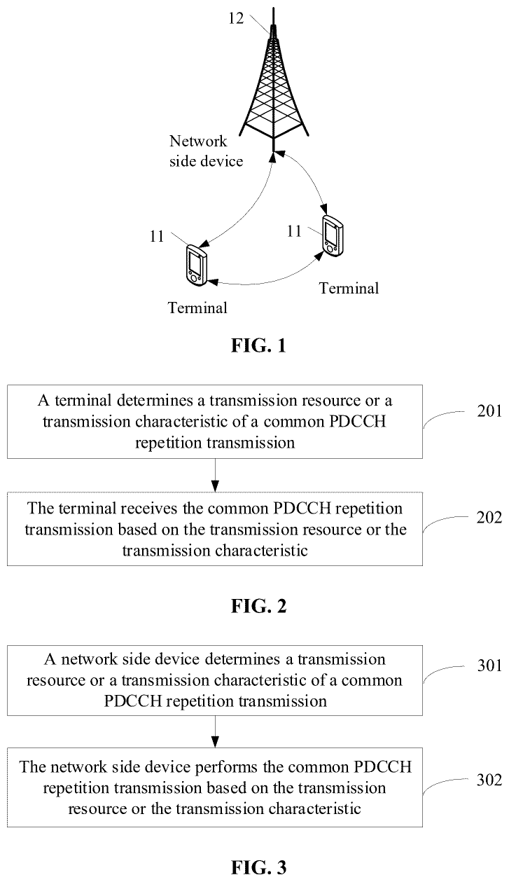

Referring to FIG. 2, FIG. 2 is a flowchart of a method for receiving a common PDCCH according to an embodiment of this application. As shown in FIG. 2, the method includes the following steps.

Step 201: A terminal determines a transmission resource or a transmission characteristic of a common PDCCH repetition transmission.

The common PDCCH includes at least one of the following:
a system information block (SIB) 1 physical downlink control channel (PDCCH), an other system information (OSI) PDCCH, a message 2 (Msg2) PDCCH, a message 4 (Msg4) PDCCH, a message B (MsgB) PDCCH, a paging PDCCH, and a PDCCH for scheduling a retransmission of a message 3 (Msg3).

The SIB1 PDCCH refers to a PDCCH for scheduling a SIB1, the OSI PDCCH refers to a PDCCH for scheduling OSI, the Msg2 PDCCH refers to a PDCCH for scheduling a Msg2, the Msg4 PDCCH refers to a PDCCH for scheduling a Msg4, the MsgB PDCCH refers to a PDCCH for scheduling a MsgB, and the paging PDCCH refers to a PDCCH for scheduling paging or used for paging.

The common PDCCH may refer to one or more PDCCHs transmitted on a common PDCCH resource. The common PDCCH resource may refer to a CORESET resource that supports a CSS, and may be a CORESET #0 or another CORESET. The CSS may include at least one of the following:
a Type0 CSS set, a Type0A CSS set, a Type1 CSS set, and a Type2 CSS set.

For example, the common PDCCH may be a PDCCH transmitted on the CORESET #0, or may be a PDCCH transmitted on a CORESET resource associated with the Type0/0A/1/2 PDCCH CSS set.

In addition, the common PDCCH transmitted on the CORESET resource associated with the CSS is also referred to as a broadcast PDCCH.

Moreover, the common PDCCH may be a common PDCCH in a non-terrestrial network (NTN) scenario, or may be a common PDCCH in a terrestrial network (TN) scenario.

In some implementations, the common PDCCH may alternatively be a PDCCH channel before the terminal enters an RRC connected state.

In the embodiments of this application, the common PDCCH repetition transmission may also be referred to as a common PDCCH repetition, or each transmission of the common PDCCH repetition transmission is referred to as a PDCCH repetition.

The transmission resource of the common PDCCH repetition transmission may be a time domain resource, a frequency domain resource, or a space domain resource occupied by the common PDCCH repetition transmission.

The transmission characteristic of the common PDCCH repetition transmission may be a transmission parameter used by a network side device for performing the common PDCCH repetition transmission, a transmission parameter in a transmission process of the common PDCCH repetition transmission, or the like.

Step 202: The terminal receives the common PDCCH repetition transmission based on the transmission resource or the transmission characteristic.

That the terminal receives the common PDCCH repetition transmission based on the transmission resource or the transmission characteristic may be to receive the common PDCCH repetition transmission on the transmission resource or receive the common PDCCH repetition transmission based on the transmission characteristic. In addition, the receiving may alternatively be monitoring or detection.

In this embodiment of this application, the terminal can perform the common PDCCH repetition transmission through the foregoing steps, to improve network coverage performance. Moreover, the common PDCCH includes the SIB1 PDCCH, the OSI PDCCH, the message 2PDCCH, the message 4 PDCCH, the message B PDCCH, the paging PDCCH, and the PDCCH for scheduling the retransmission of the message 3. Therefore, the terminal can better receive a message in a random access procedure, to improve random access performance of the terminal.

In an optional implementation, the transmission resource includes at least one of the following:
a slot and a monitoring occasion.

The slot may be a slot corresponding to each transmission of the common PDCCH, and the monitoring occasion may be a monitoring occasion corresponding to each transmission of the common PDCCH.

In some implementations, the slot includes at least one of the following:
a physical slot and an available slot.

The physical slot for the common PDCCH repetition transmission may be consecutive or non-consecutive physical slots. In other words, the physical slot includes consecutive physical slots or non-consecutive physical slots. Time-frequency resource positions for the common PDCCH repetition transmission in the consecutive physical slots may be the same or different. The available slot for the common PDCCH repetition transmission may be consecutive or non-consecutive available slots.

In some implementations, the monitoring occasion includes at least one of the following:
a physical PDCCH monitoring occasion and an available PDCCH monitoring occasion.

The physical PDCCH monitoring occasion for the common PDCCH repetition transmission may be consecutive or non-consecutive physical PDCCH monitoring occasions. In other words, the physical PDCCH monitoring occasion includes consecutive physical PDCCH monitoring occasions or non-consecutive physical PDCCH monitoring occasions. Time-frequency domain resource positions for the common PDCCH repetition transmission in the consecutive physical PDCCH monitoring occasions may be the same or different. The available PDCCH monitoring occasion for the common PDCCH repetition transmission may be consecutive or non-consecutive available PDCCH monitoring occasions.

The available PDCCH monitoring occasion may also be referred to as a usable PDCCH monitoring occasion.

In the implementation, the slot or the monitoring occasion for the common PDCCH repetition transmission may be determined, so that the terminal monitors the common PDCCH based on these slots or monitoring occasions, to improve reliability of receiving the common PDCCH.

Optionally, the consecutive physical slots belong to a same search space, and the consecutive physical slots are physical slots in which PDCCH monitoring occasions are located; or the consecutive physical slots belong to multiple search spaces, and the consecutive physical slots are physical slots in which PDCCH monitoring occasions are located; or
the consecutive physical PDCCH monitoring occasions belong to a same search space; or the consecutive physical PDCCH monitoring occasions belong to different search spaces.

That the consecutive physical slots belong to a same search space may be understood as follows: The terminal monitors the common PDCCH in consecutive physical slots and on PDCCH monitoring occasions in a same search space. In this way, the common PDCCH can be monitored in the consecutive physical slots in the same search space, to reduce power consumption overheads of the terminal.

That the consecutive physical slots belong to multiple search spaces may be understood as follows: The terminal monitors the common PDCCH in consecutive physical slots and on PDCCH monitoring occasions in different search spaces. In this way, the common PDCCH repetition transmission is more flexible, to enable the terminal to more easily monitor the common PDCCH.

The consecutive physical PDCCH monitoring occasions belong to the same search space. In this way, the common PDCCH can be monitored in the consecutive physical PDCCH monitoring occasions in the same search space, to reduce power consumption overheads of the terminal.

The consecutive physical PDCCH monitoring occasions belong to the different search spaces. In this way, the common PDCCH repetition transmission is more flexible, to enable the terminal to more easily monitor the common PDCCH.

Optionally, the available slot meets at least one of the following:
in the available slot, a symbol on which the common PDCCH repetition transmission is located does not overlap a symbol on which an SSB is located;
in the available slot, a symbol on which the common PDCCH repetition transmission is located does not overlap a symbol on which a physical random access channel (PRACH) is located;
in the available slot, a symbol on which the common PDCCH repetition transmission is located does not overlap a symbol on which a message A physical uplink shared channel PUSCH is located;
in the available slot, a symbol on which the common PDCCH repetition transmission is located does not overlap a symbol corresponding to another search space, where the another search space is different from a search space corresponding to the common PDCCH repetition transmission;
in the available slot, a symbol on which the common PDCCH repetition transmission is located does not overlap a symbol corresponding to another control resource set CORESET, where the another CORESET is different from a CORESET corresponding to the common PDCCH repetition transmission;
in the available slot, a symbol on which the common PDCCH repetition transmission is located does not overlap a symbol on which another common PDCCH is located;
in the available slot, a symbol on which the common PDCCH repetition transmission is located is a downlink symbol; and
in the available slot, a symbol on which the common PDCCH repetition transmission is located is a flexible symbol.

Determining of the available slot meeting at least one of the foregoing may be to determine the available slot meeting at least one of the foregoing as an available slot used for the common PDCCH repetition transmission, or determine, based on at least one of the foregoing, a symbol used for the common PDCCH repetition transmission in the available slot.

The available slot meeting at least one of the foregoing may also be referred to as the common PDCCH repetition transmission meeting at least one of the foregoing in the available slot.

At least one of the foregoing may be indicated by a network side, or agreed upon in a protocol.

In the implementation, because the available slot meets at least one of the foregoing, this can reduce transmission collisions and further improve reliability of receiving the common PDCCH by the terminal.

Optionally, the available PDCCH monitoring occasion meets at least one of the following:
a symbol corresponding to the available PDCCH monitoring occasion does not overlap a symbol on which an SSB is located;
a symbol corresponding to the available PDCCH monitoring occasion does not overlap a symbol on which a PRACH is located;
a symbol corresponding to the available PDCCH monitoring occasion does not overlap a symbol on which a message A PUSCH is located;
a symbol corresponding to the available PDCCH monitoring occasion does not overlap a symbol corresponding to another search space, where the another search space is different from a search space corresponding to the common PDCCH repetition transmission;
a symbol corresponding to the available PDCCH monitoring occasion does not overlap a symbol corresponding to another control resource set CORESET, where the another CORESET is different from a CORESET corresponding to the common PDCCH repetition transmission;
a symbol corresponding to the available PDCCH monitoring occasion does not overlap a symbol on which another common PDCCH is located;
a symbol corresponding to the available PDCCH monitoring occasion is a downlink symbol; and
a symbol corresponding to the available PDCCH monitoring occasion is a flexible symbol.

Determining of the available PDCCH monitoring occasion meeting at least one of the foregoing conditions may be to determine the available PDCCH monitoring occasion meeting the foregoing condition as an available PDCCH monitoring occasion used for the common PDCCH repetition transmission, or determine, based on at least one of the foregoing conditions, a symbol used for the common PDCCH repetition transmission in the available PDCCH monitoring occasion.

The available PDCCH monitoring occasion meeting at least one of the foregoing conditions may also be referred to as the common PDCCH repetition transmission meeting at least one of the foregoing conditions in the available PDCCH monitoring occasion.

At least one of the foregoing conditions may be indicated by the network side, or agreed upon in the protocol.

In the implementation, because the available PDCCH monitoring occasion meets at least one of the foregoing conditions, this can reduce transmission collisions and further improve reliability of receiving the common PDCCH by the terminal.

Optionally, in a case that the common PDCCH repetition transmission is an inter-slot repetition transmission, a count of a quantity of repetitions for the common PDCCH repetition transmission includes at least one of the following:
a quantity of physical slots and a quantity of available slots; or
in a case that the common PDCCH repetition transmission is an inter-occasion repetition transmission, a count of a quantity of repetitions for the common PDCCH repetition transmission includes at least one of the following:
a quantity of physical PDCCH monitoring occasions and a quantity of available PDCCH monitoring occasions.

That the count of a quantity of repetitions for the common PDCCH repetition transmission includes a quantity of physical slots may be that all physical slots for the common PDCCH repetition transmission are counted in the configured count of the quantity of repetitions. That the count of a quantity of repetitions for the common PDCCH repetition transmission includes a quantity of available slots may be that all available slots for the common PDCCH repetition transmission are counted in the configured count of the quantity of repetitions.

That the count of a quantity of repetitions for the common PDCCH repetition transmission includes a quantity of physical PDCCH monitoring occasions may be that all physical PDCCH monitoring occasions for the common PDCCH repetition transmission are counted in the configured count of the quantity of repetitions. That the count of a quantity of repetitions for the common PDCCH repetition transmission includes a quantity of available PDCCH monitoring occasions may be that all available PDCCH monitoring occasions for the common PDCCH repetition transmission are counted in the configured count of the quantity of repetitions.

In the implementation, the quantity of repetitions is counted based on the quantity of physical slots, the quantity of available slots, the quantity of physical PDCCH monitoring occasions, and the quantity of available PDCCH monitoring occasions, to improve accuracy of counting the quantity of repetitions and further avoid mistaken monitoring of the terminal.

Optionally, the method further includes:
in a case that the transmission resource includes a collision slot in which the common PDCCH repetition transmission collides with another channel, performing first processing or second processing on the collision slot, where
the first processing includes: discarding receiving of the common PDCCH repetition transmission in the collision slot; and
the second processing includes: discarding receiving of the another channel in the collision slot.

The collision slot is a slot in which the common PDCCH repetition transmission collides with the another channel. This collision may be that resources all or partially overlap.

Use of the first processing or the second processing may be determined based on a configuration on the network side or the protocol agreement, or based on a channel type.

Optionally, the performing first processing or second processing on the collision slot includes:
in a first case, performing the first processing on the collision slot, where the first case includes at least one of the following:
the common PDCCH includes a system information block SIB1 PDCCH, and the another channel includes an SSB;
the common PDCCH includes a message 2 PDCCH, and the another channel includes at least one of the following: an SSB, a SIB1 PDCCH, a SIB1 PDSCH, a PRACH, a message A PRACH, and a message A PUSCH;
the common PDCCH includes a message 4 PDCCH or a message B PDCCH, and the another channel includes at least one of the following: an SSB, a SIB1 PDCCH, a SIB1 PDSCH, a PRACH, a message A PRACH, a message A PUSCH, a message 2 PDCCH, a message 2 PDSCH, a message 3, and a PDCCH for scheduling a retransmission of a message 3;
the common PDCCH includes a PDCCH for scheduling a retransmission of a message 3, and the another channel includes at least one of the following: an SSB, a SIB1 PDCCH, a SIB1 PDSCH, a PRACH, a message A PRACH, a message A PUSCH, a message 2 PDCCH, a message 2 PDSCH, and a message 3; and
the common PDCCH includes a paging PDCCH, and the another channel includes at least one of the following: an SSB, a SIB1 PDCCH, a SIB1 PDSCH, a PRACH, a message A PRACH, a message A PUSCH, a message 2 PDCCH, a message 2 PDSCH, a message 3, a PDCCH for scheduling a retransmission of a message 3, a message 4 PDCCH, a message 4 PDSCH, and a physical uplink control channel PUCCH for hybrid automatic repeat request HARQ feedback of a message 4.

For another example, in a second case, performing the second processing on the collision slot, where the second case includes at least one of the following:
the common PDCCH includes a SIB1 PDCCH, and the another channel includes at least one of the following: another PDCCH, a non-SIB1 PDSCH, a PRACH, and a common PUSCH; and
the common PDCCH includes at least one of a message 2 PDCCH, a message 4 PDCCH, and a message B PDCCH, and the another channel includes at least one of the following:
a PDCCH other than a SIB1 PDCCH;
a PDSCH other than a SIB1 PDSCH;
a common PUSCH; and
a dedicated PUUCH.

In the implementation, through the first processing and the second processing, collisions can be reduced, to improve receiving reliability of a downlink channel.

Optionally, the performing first processing or second processing on the collision slot includes:
performing the first processing or the second processing on the collision slot according to any one of the following rules:
prioritizing a 1^{st} transmission of the common PDCCH repetition transmission;
prioritizing transmission of a channel with a high priority; and
in a case of a same priority, prioritizing transmission of a channel with earlier generation time.

The priority of the channel may be agreed upon in the protocol or configured by the network side. For example, a priority order is: the 1^{st} transmission of the common PDCCH repetition transmission>a transmission other than the 1^{st} transmission of the common PDCCH repetition transmission>another PDCCH>a PDSCH.

In the implementation, the 1^{st} transmission, the channel with the high priority or the earlier generation time can be prioritized to improve receiving performance of the downlink channel of the terminal.

In an optional implementation, the transmission resource includes at least one of the following indicated transmission resources:
a transmission resource indicated by system information;
a transmission resource indicated by an SSB;
a transmission resource indicated by a PDCCH resource configuration table;
a transmission resource indicated by a CORESET;
a transmission resource indicated by a search space;
a transmission resource indicated by a PDCCH monitoring occasion;
a transmission resource indicated by a PRACH resource;
a transmission resource indicated by a PRACH format; and
a transmission resource indicated by a repetition count type.

The system information includes a master information block (MIB) or a SIB.

The indication includes an explicit indication or an implicit indication. For example, the CORESET, the search space, the PDCCH monitoring occasion, the PRACH resource, or the PRACH format has an association relationship with the transmission resource, so that the transmission resource indicated by the CORESET, the search space, the PDCCH monitoring occasion, the PRACH resource, or the PRACH format is determined based on the association relationship. The association relationship may be agreed upon in the protocol or configured by the network side.

The repetition count type may include a physical slot-based count type or an available slot-based count type. In addition, the repetition count type may be configured by the network side, agreed upon in the protocol, or default. For example, the count type is to count the quantity of repetitions by default based on the physical slot/physical occasion; or the count type is to count the quantity of repetitions by default based on the available slot/available occasion. For another example, the terminal receives indication information sent by the network side device. The indication information is used to indicate a count type used by the terminal to receive the common PDCCH repetition transmission. The count type includes counting the quantity of repetitions based on the physical slot or based on the available slot.

The transmission resource indicated by the repetition count type may be that a resource corresponding to the repetition count type is the transmission resource. For example, the repetition count type is to count the quantity of repetitions based on the physical slot. In this case, transmission slots for the common PDCCH are N consecutive slots starting from a start position of a time domain resource for the common PDCCH repetition transmission, where N is a positive integer. In addition, in a case that the common PDCCH repetition transmission is an inter-slot repetition transmission, N is equal to a quantity K of repetitions, where K is a positive integer. In a case that the common PDCCH repetition transmission is an intra-slot repetition transmission, N is equal to a quantity of slots occupied by the time domain resource for the common PDCCH repetition transmission.

In the implementation, the transmission resource can be determined based on multiple types of information, and this can also avoid introducing additional signaling, to reduce transmission overheads.

In an optional implementation, the transmission resource meets one of the following conditions:
a slot in which the 1^{st} transmission of the common PDCCH repetition transmission is located is an available slot;
a slot in which a transmission occasion of the 1^{st} transmission of the common PDCCH repetition transmission is located is an available slot;
a slot in which the common PDCCH repetition transmission is located is an available slot;
a transmission occasion of the common PDCCH repetition transmission is an available transmission occasion;
a slot in which the common PDCCH repetition transmission is located is a physical slot;
a transmission occasion of the common PDCCH repetition transmission is a physical transmission occasion; and
a resource in which the common PDCCH repetition transmission is located is associated with an SSB.

That a resource in which the common PDCCH repetition transmission is located is associated with an SSB includes at least one of the following:
a slot in which the common PDCCH repetition transmission is located is associated with an SSB; and
a transmission slot in which the common PDCCH repetition transmission is located is associated with an SSB.

In the implementation, the transmission resource is constrained, so that the common PDCCH repetition transmission can be more reliable.

In some implementations, that a slot in which the common PDCCH repetition transmission is located is associated with an SSB includes at least one of the following:
in a case that each transmission of the common PDCCH repetition transmission is quasi co-located (QCL) with a same SSB, a resource for each transmission of the common PDCCH repetition transmission is associated with transmission time of the SSB of a same beam; and
in a case that each transmission of the common PDCCH repetition transmission is QCLed with a different SSB, a resource for each transmission of the common PDCCH repetition transmission is associated with transmission time of the SSB of a different beam.

That a resource for each transmission of the common PDCCH repetition transmission is associated with transmission time of the SSB of a same beam may be that a slot or a transmission occasion for each transmission of the common PDCCH repetition transmission is determined based on the transmission time of the SSB of the same beam. For example, the common PDCCH repetition transmission is associated with SSB transmission of a beam #1. In this case, the resource for each transmission of the common PDCCH may be obtained through an SSB of the beam #1. For example, a fixed offset is present.

That a resource for each transmission of the common PDCCH repetition transmission is associated with transmission time of the SSB of a different beam may be that the resource for each transmission of the common PDCCH repetition transmission is determined based on the transmission time of the SSB of the different beam. For example, a slot or a transmission occasion for each transmission of the common PDCCH is determined respectively relative to transmission moments of an SSB of a beam #1, an SSB of a beam #2, an SSB of a beam #3, . . . For example, there is a one-to-one correspondence.

In the implementation, the resource for each transmission of the common PDCCH may be determined through the associated SSB, to reduce configuration overheads.

In an optional implementation, the transmission characteristic includes at least one of the following:
an average power, an average delay, delay spread, Doppler frequency shift, Doppler spread, a spatial receive parameter (spatial Rx parameter), and a beam.

In some implementations, the average power, the average delay, the delay spread, the Doppler frequency shift, the Doppler spread, the spatial receive parameter (spatial Rx parameter), and the beam may include an average power, an average delay, delay spread, a Doppler frequency shift, Doppler spread, a spatial receive parameter (spatial Rx parameter), and a beam that correspond to each transmission of the common PDCCH repetition transmission.

The average power may be an average power of multiple transmissions of the common PDCCH repetition transmission, or may be an average power of each transmission. The average delay may be an average delay of multiple transmissions of the common PDCCH repetition transmission, or may be an average delay of each transmission.

In the embodiments of this application, that the terminal receives the common PDCCH based on the transmission characteristic may be to receive the common PDCCH in a manner of receiving a PDCCH based on transmission performance as defined in the protocol.

In the implementation, at least one of the average power, the average delay, the delay spread, the Doppler frequency shift, the Doppler spread, the spatial receive parameter, and the beam may be indicated by the network side, or determined based on the protocol agreement.

In addition, in some implementations, the terminal may receive the common PDCCH using a part of characteristics in at least one of the foregoing, or may ignore a part of transmission characteristics, that is, receive the common PDCCH based on the part of transmission characteristics.

In the implementation, the common PDCCH can be received based on at least one of the average power, the average delay, the delay spread, the Doppler frequency shift, the Doppler spread, the spatial receive parameter, and the beam, to improve receiving reliability of the common PDCCH.

In an optional implementation, transmission characteristics of different transmissions of the common PDCCH repetition transmission have the following cases:
having a same transmission characteristic, or having different transmission characteristics.

Having the same transmission characteristic or having different transmission characteristics may be determined based on a configuration on the network side, or may be determined based on the protocol agreement.

In the implementation, because different transmissions that support the common PDCCH repetition transmission have the same transmission characteristic, this can reduce configuration overheads and reduce complexity of receiving the common PDCCH by the terminal. In addition, different transmissions that support the common PDCCH repetition transmission have different transmission characteristics, this can achieve more flexible transmission of the common PDCCH.

Optionally, in a case that transmission characteristics of different transmissions of the common PDCCH repetition transmission are the same, multiple transmissions of the common PDCCH repetition transmission are QCLed with at least one downlink reference signal (RS), or a demodulation reference signal (DMRS) antenna port of the common PDCCH repetition transmission is QCLed with at least one downlink reference signal; or
in a case that transmission characteristics of different transmissions of the common PDCCH repetition transmission are different, an i^{th} transmission of the common PDCCH repetition transmission is QCLed with at least one downlink reference signal, or a DMRS antenna port of an i^{th} transmission of the common PDCCH repetition transmission is QCLed with at least one downlink reference signal, and a value of i is greater than or equal to 1 and less than or equal to a quantity of repetitions of the common PDCCH.

Optionally, the downlink reference signal includes at least one of the following:
a reference signal associated with a PDCCH sent repeatedly;
a reference signal associated with a PRACH;
a reference signal associated with a CORESET in which a PDCCH is located;
a reference signal sent by a serving cell; and
a reference signal associated with a PRACH repetition transmission, where the reference signal includes an SSB or a channel state information reference signal (CSI-RS).

For example, the SSB included in the downlink reference signal includes at least one of the following:
an SSB associated with a PDCCH sent repeatedly;
an SSB associated with a PRACH;
an SSB associated with a CORESET in which a PDCCH is located;
an SSB sent by a serving cell; and
an SSB associated with a PRACH repetition transmission, such as a 1^{st} or last SSB associated.

For example, the CSI-RS included in the downlink reference signal includes at least one of the following:
a CSI-RS associated with a PDCCH sent repeatedly;
a CSI-RS associated with a PRACH;
a CSI-RS associated with a CORESET in which a PDCCH is located;
a CSI-RS sent by a serving cell; and
a CSI-RS associated with a PRACH repetition transmission, such as a 1^{st o}r last CSI-RS associated.

In the implementation, the downlink reference signal can be QCLed with the common PDCCH repetition transmission. This can avoid introducing additional configuration signaling, to reduce configuration overheads.

Optionally, in a case that transmission characteristics of different transmissions of the common PDCCH repetition transmission are different, a beam of another transmission of the common PDCCH repetition transmission includes at least one of the following:
a beam determined by adding an angle offset to a beam for a transmission, of the common PDCCH repetition transmission, closest to the another transmission; and
a beam indicated by a beam pattern, where
the another transmission is a transmission different from the i^{th} transmission.

The angle offset may be agreed upon in the protocol or configured by the network side.

The beam pattern may indicate a beam for each transmission.

In the implementation, the beam for each transmission beam can be accurately determined, to improve reliability of receiving the common PDCCH by the terminal.

Optionally, in a case that the common PDCCH repetition transmission includes transmissions of different beams, the different beams are multiple beams divided from a downlink beam corresponding to an SSB associated with the common PDCCH repetition transmission.

The multiple beams divided from the downlink beam corresponding to the SSB associated with the common PDCCH repetition transmission may be referred to as narrow beams or fine beams, and specifically, may be narrower/finer beams divided from the downlink beam corresponding to the associated SSB. For example, in a case that the downlink beam corresponding to the associated SSB is a wide beam of 30 degrees, the multiple beams may be three narrow beams pointing at 30 degrees and 30±2 degrees.

In the implementation, because the different beams of the common PDCCH repetition transmission are the multiple beams divided from the downlink beam corresponding to the SSB associated with the common PDCCH repetition transmission, the multiple beams can be associated with the beam of the same SSB, so that the terminal better monitors the common PDCCH on the multiple beams.

In an optional implementation, the transmission characteristic of the common PDCCH repetition transmission is at least partially the same as a transmission characteristic of a downlink reference signal resource corresponding to a PRACH resource used by the terminal.

The downlink reference signal resource may include at least one of the following:
an SSB resource and a CSI-RS resource.

The transmission characteristic of the downlink reference signal resource may be a transmission characteristic of transmitting a downlink reference signal on the downlink reference signal resource.

In the implementation, because the transmission characteristic of the common PDCCH repetition transmission is at least partially the same as the transmission characteristic of the downlink reference signal resource corresponding to the PRACH resource used by the terminal, this can reduce configuration signaling overheads for transmission performance.

In an optional implementation, in a case that a repetition transmission is used for a PRACH used by the terminal, a transmission characteristic of an i^{th} transmission of the common PDCCH repetition transmission is at least partially the same as a transmission characteristic of an i^{th} transmission of the PRACH, and a value of i is greater than or equal to 1 and less than or equal to min{a maximum quantity of repetitions of the common PDCCH, a maximum quantity of repetitions of the PRACH}.

A quantity of repetitions for the common PDCCH repetition transmission is the same as a quantity of repetitions for the downlink reference signal, or a quantity of repetitions for the common PDCCH repetition transmission is less than a quantity of repetitions for the downlink reference signal. For example, when a quantity of repetitions for the PRACH is the same as a quantity of repetitions for the common PDCCH, both the PRACH and the common PDCCH use at least partially the same transmission characteristics for their transmissions in a one-to-one correspondence.

In some implementations, in a case that the quantity of repetitions for the common PDCCH repetition transmission is greater than the quantity of repetitions for the downlink reference signal, a characteristic of a transmission whose quantity of repetitions in the common PDCCH repetition transmission exceeds the quantity of repetitions for the downlink reference signal may be determined based on the other implementations, such as the configuration on the network side or the protocol agreement.

In the implementation, because the transmission characteristic of the i^{th} transmission of the common PDCCH repetition transmission is at least partially the same as the transmission characteristic of the i^{th} transmission of the PRACH, this can reduce configuration signaling overheads for transmission performance.

In the embodiments of this application, the terminal determines the transmission resource or the transmission characteristic of the common PDCCH repetition transmission. The terminal receives the common PDCCH repetition transmission based on the transmission resource or the transmission characteristic, where the common PDCCH includes at least one of the following: the SIB1 PDCCH, the OSI PDCCH, the message 2 PDCCH, the message 4 PDCCH, the message B PDCCH, the paging PDCCH, and the PDCCH for scheduling the retransmission of the message 3. In this way, the terminal can perform the common PDCCH repetition transmission, to improve network coverage performance.

For example, the network side device sends scheduling information for some common messages (such as RMSI/OSI/Paging/Msg2/MsgB/Msg4) using the common PDCCH before an RRC connection of the terminal is established. In this embodiment of this application, in some scenarios (such as an NTN scenario), a PDCCH for scheduling the Msg2 is repeatedly transmitted, so that a success rate of receiving the PDCCH by the terminal is improved, to complete random access and establish the RRC connection.

Referring to FIG. 3, FIG. 3 is a flowchart of a method for sending a common PDCCH according to an embodiment of this application. As shown in FIG. 3, the method includes the following steps.

Step 301: A network side device determines a transmission resource or a transmission characteristic of a common PDCCH repetition transmission.

Step 302: The network side device performs the common PDCCH repetition transmission based on the transmission resource or the transmission characteristic.

The common PDCCH includes at least one of the following:
a system information block SIB1 PDCCH, an other system information OSI PDCCH, a message 2 PDCCH, a message 4 PDCCH, a message B PDCCH, a paging PDCCH, and a PDCCH for scheduling a retransmission of a message 3.

Optionally, the transmission resource includes at least one of the following:
a slot and a monitoring occasion, where
the slot includes at least one of the following:
a physical slot and an available slot; and
the monitoring occasion includes at least one of the following:
a physical PDCCH monitoring occasion and an available PDCCH monitoring occasion.

Optionally, the physical slot includes consecutive physical slots; or
the physical PDCCH monitoring occasion includes consecutive physical PDCCH monitoring occasions.

Optionally, the consecutive physical slots belong to a same search space, and the consecutive physical slots are physical slots in which PDCCH monitoring occasions are located; or the consecutive physical slots belong to multiple search spaces, and the consecutive physical slots are physical slots in which PDCCH monitoring occasions are located; or
the consecutive physical PDCCH monitoring occasions belong to a same search space; or the consecutive physical PDCCH monitoring occasions belong to different search spaces.

Optionally, the available slot meets at least one of the following:
in the available slot, a symbol on which the common PDCCH repetition transmission is located does not overlap a symbol on which a synchronization signal block SSB is located;
in the available slot, a symbol on which the common PDCCH repetition transmission is located does not overlap a symbol on which a physical random access channel PRACH is located;
in the available slot, a symbol on which the common PDCCH repetition transmission is located does not overlap a symbol on which a message A physical uplink shared channel PUSCH is located;
in the available slot, a symbol on which the common PDCCH repetition transmission is located does not overlap a symbol corresponding to another search space, where the another search space is different from a search space corresponding to the common PDCCH repetition transmission;
in the available slot, a symbol on which the common PDCCH repetition transmission is located does not overlap a symbol corresponding to another control resource set CORESET, where the another CORESET is different from a CORESET corresponding to the common PDCCH repetition transmission;
in the available slot, a symbol on which the common PDCCH repetition transmission is located does not overlap a symbol on which another common PDCCH is located;
in the available slot, a symbol on which the common PDCCH repetition transmission is located is a downlink symbol; and
in the available slot, a symbol on which the common PDCCH repetition transmission is located is a flexible symbol.

Optionally, the available PDCCH monitoring occasion meets at least one of the following:
a symbol corresponding to the available PDCCH monitoring occasion does not overlap a symbol on which an SSB is located;
a symbol corresponding to the available PDCCH monitoring occasion does not overlap a symbol on which a PRACH is located;
a symbol corresponding to the available PDCCH monitoring occasion does not overlap a symbol on which a message A PUSCH is located;
a symbol corresponding to the available PDCCH monitoring occasion does not overlap a symbol corresponding to another search space, where the another search space is different from a search space corresponding to the common PDCCH repetition transmission;
a symbol corresponding to the available PDCCH monitoring occasion does not overlap a symbol corresponding to another control resource set CORESET, where the another CORESET is different from a CORESET corresponding to the common PDCCH repetition transmission;
a symbol corresponding to the available PDCCH monitoring occasion does not overlap a symbol on which another common PDCCH is located;
a symbol corresponding to the available PDCCH monitoring occasion is a downlink symbol; and
a symbol corresponding to the available PDCCH monitoring occasion is a flexible symbol.

Optionally, in a case that the common PDCCH repetition transmission is an inter-slot repetition transmission, a count of a quantity of repetitions for the common PDCCH repetition transmission includes at least one of the following:
a quantity of physical slots and a quantity of available slots; or
in a case that the common PDCCH repetition transmission is an inter-occasion repetition transmission, a count of a quantity of repetitions for the common PDCCH repetition transmission includes at least one of the following:
a quantity of physical PDCCH monitoring occasions and a quantity of available PDCCH monitoring occasions.

Optionally, the method further includes:
in a case that the transmission resource includes a collision slot in which the common PDCCH repetition transmission collides with another channel, performing first processing or second processing on the collision slot, where
the first processing includes: discarding the common PDCCH repetition transmission in the collision slot; and
the second processing includes: discarding the another channel in the collision slot.

Optionally, the performing first processing or second processing on the collision slot includes:
in a first case, performing the first processing on the collision slot, where the first case includes at least one of the following:
the common PDCCH includes a system information block SIB1 PDCCH, and the another channel includes an SSB;
the common PDCCH includes a message 2 PDCCH, and the another channel includes at least one of the following: an SSB, a SIB1 PDCCH, a SIB1 PDSCH, a PRACH, a message A PRACH, and a message A PUSCH;
the common PDCCH includes a message 4 PDCCH or a message B PDCCH, and the another channel includes at least one of the following: an SSB, a SIB1 PDCCH, a SIB1 PDSCH, a PRACH, a message A PRACH, a message A PUSCH, a message 2 PDCCH, a message 2 PDSCH, a message 3, and a PDCCH for scheduling a retransmission of a message 3;
the common PDCCH includes a PDCCH for scheduling a retransmission of a message 3, and the another channel includes at least one of the following: an SSB, a SIB1 PDCCH, a SIB1 PDSCH, a PRACH, a message A PRACH, a message A PUSCH, a message 2 PDCCH, a message 2 PDSCH, and a message 3; and
the common PDCCH includes a paging PDCCH, and the another channel includes at least one of the following: an SSB, a SIB1 PDCCH, a SIB1 PDSCH, a PRACH, a message A PRACH, a message A PUSCH, a message 2 PDCCH, a message 2 PDSCH, a message 3, a PDCCH for scheduling a retransmission of a message 3, a message 4 PDCCH, a message 4 PDSCH, and a physical uplink control channel PUCCH for hybrid automatic repeat request HARQ feedback of a message 4; or
in a second case, performing the second processing on the collision slot, where the second case includes at least one of the following:
the common PDCCH includes a SIB1 PDCCH, and the another channel includes at least one of the following: another PDCCH, a non-SIB1 PDSCH, a PRACH, and a common PUSCH; and
the common PDCCH includes at least one of a message 2 PDCCH, a message 4 PDCCH, and a message B PDCCH, and the another channel includes at least one of the following:
a PDCCH other than a SIB1 PDCCH;
a PDSCH other than a SIB1 PDSCH;
a common PUSCH; and
a dedicated PUCCH.

Optionally, the performing first processing or second processing on the collision slot includes:
performing the first processing or the second processing on the collision slot according to any one of the following rules:
prioritizing a 1^{st} transmission of the common PDCCH repetition transmission;
prioritizing transmission of a channel with a high priority; and
in a case of a same priority, prioritizing transmission of a channel with earlier generation time.

Optionally, the transmission resource includes at least one of the following indicated transmission resources:
a transmission resource indicated by system information;
a transmission resource indicated by an SSB;
a transmission resource indicated by a PDCCH resource configuration table;
a transmission resource indicated by a CORESET;
a transmission resource indicated by a search space;
a transmission resource indicated by a PDCCH monitoring occasion;
a transmission resource indicated by a PRACH resource;
a transmission resource indicated by a PRACH format; and
a transmission resource indicated by a repetition count type.

Optionally, the transmission resource meets one of the following conditions:
a slot in which the 1^{st} transmission of the common PDCCH repetition transmission is located is an available slot;
a slot in which a transmission occasion of the 1^{st} transmission of the common PDCCH repetition transmission is located is an available slot;
a slot in which the common PDCCH repetition transmission is located is an available slot;
a transmission occasion of the common PDCCH repetition transmission is an available transmission occasion;
a slot in which the common PDCCH repetition transmission is located is a physical slot;
a transmission occasion of the common PDCCH repetition transmission is a physical transmission occasion; and
a slot in which the common PDCCH repetition transmission is located is associated with an SSB; and
a transmission occasion of the common PDCCH repetition transmission is associated with an SSB.

Optionally, that a slot in which the common PDCCH repetition transmission is located is associated with an SSB includes at least one of the following:
in a case that each transmission of the common PDCCH repetition transmission is quasi co-located QCLed with a same SSB, a resource for each transmission of the common PDCCH repetition transmission is associated with transmission time of the SSB of a same beam; and
in a case that each transmission of the common PDCCH repetition transmission is QCLed with a different SSB, a resource for each transmission of the common PDCCH repetition transmission is associated with transmission time of the SSB of a different beam.

Optionally, in a case that transmission characteristics of different transmissions of the common PDCCH repetition transmission are the same, multiple transmissions of the common PDCCH repetition transmission are QCLed with at least one downlink reference signal, or a demodulation reference signal DMRS antenna port of the common PDCCH repetition transmission is QCLed with at least one downlink reference signal; or
in a case that transmission characteristics of different transmissions of the common PDCCH repetition transmission are different, an i^{th} transmission of the common PDCCH repetition transmission is QCLed with at least one downlink reference signal, or a DMRS antenna port of an i^{th} transmission of the common PDCCH repetition transmission is QCLed with at least one downlink reference signal, and a value of i is greater than or equal to 1 and less than or equal to a quantity of repetitions of the common PDCCH.

Optionally, the downlink reference signal includes at least one of the following:
a reference signal associated with a PDCCH sent repeatedly;
a reference signal associated with a PRACH;
a reference signal associated with a CORESET in which a PDCCH is located;
a reference signal sent by a serving cell; and
a reference signal associated with a PRACH repetition transmission, where
the reference signal includes an SSB or a CSI-RS.

Optionally, in a case that transmission characteristics of different transmissions of the common PDCCH repetition transmission are different, a beam of another transmission of the common PDCCH repetition transmission includes at least one of the following:
a beam determined by adding an angle offset to a beam for a transmission, of the common PDCCH repetition transmission, closest to the another transmission; and
a beam indicated by a beam pattern, where
the another transmission is a transmission different from the i^{th} transmission.

Optionally, in a case that the common PDCCH repetition transmission includes transmissions of different beams, the different beams are multiple beams divided from a downlink beam corresponding to an SSB associated with the common PDCCH repetition transmission.

Optionally, the transmission characteristic of the common PDCCH repetition transmission is at least partially the same as a transmission characteristic of a downlink reference signal resource corresponding to a PRACH resource used by the terminal.

Optionally, in a case that a repetition transmission is used for a PRACH used by the terminal, a transmission characteristic of an i^{th} transmission of the common PDCCH repetition transmission is at least partially the same as a transmission characteristic of an i^{th} transmission of the PRACH, and a value of i is greater than or equal to 1 and less than or equal to min {a maximum quantity of repetitions of the common PDCCH, a maximum quantity of repetitions of the PRACH}.

It should be noted that this embodiment is used as an implementation of the network side device corresponding to the embodiment shown in FIG. 2. For a specific implementation of this embodiment, refer to the related descriptions of the embodiment shown in FIG. 2. To avoid repetition, details are not described in this embodiment again.

The method provided in embodiments of this application is described as examples below by using a plurality of embodiments:

### Embodiment 1

This embodiment mainly describes determining of a transmission resource of a common PDCCH repetition transmission. Details are as follows:

In some embodiments, a slot for the common PDCCH repetition transmission is determined based on physical slots. The physical slots may be consecutive physical slots, for example: at least one of the following:
the consecutive physical slots are used for a PDCCH repetition, where positions of resources and resource elements (RE) on which the PDCCH repetition is located in the consecutive physical slots may be the same or different;
consecutive physical slots belonging to PDCCH monitoring occasions in a same search space are used for a PDCCH repetition; and
consecutive physical slots belonging to PDCCH monitoring occasions in multiple search spaces are used for a PDCCH repetition.

In addition, for an inter-slot repetition transmission, all these physical slots are counted in the configured quantity of repetitions.

In some embodiments, a PDCCH occasion for the common PDCCH repetition transmission is determined based on physical PDCCH monitoring occasions. The physical PDCCH monitoring occasions may be consecutive physical PDCCH monitoring occasions, for example: at least one of the following:
consecutive physical PDCCH monitoring occasions are used for a PDCCH repetition, where positions of symbols and REs on which the PDCCH repetition in the consecutive physical PDCCH monitoring occasions herein is located may be the same or different;
consecutive physical PDCCH monitoring occasions including a same search space are used for a PDCCH repetition transmission; and
consecutive physical PDCCH monitoring occasions including multiple search spaces are used for a PDCCH repetition transmission.

Further, for an inter-occasion repetition transmission, all these physical PDCCH monitoring occasions are counted in the configured quantity of repetitions.

In some embodiments, resolution of a collision between the physical slot-based common PDCCH repetition and another channel includes at least one of the following:

When there is a collision with the another channel, the current common PDCCH repetition is discarded. For example, when the common PDCCH is a SIB1 PDCCH, the another channel may be an SSB. For another example, when the common PDCCH is a Msg2 PDCCH, the another channel may be one or more of an SSB, a SIB1 PDCCH/PDSCH, a PRACH, and a MsgA PRACH/PUSCH. For another example, when the common PDCCH is a Msg4 PDCCH or a MsgB PDCCH, the another channel may be one or more of an SSB, a SIB1 PDCCH/PDSCH, a PRACH, a MsgA PRACH/PUSCH, a Msg2 PDCCH/PDSCH, a Msg3, and a PDCCH for scheduling a retransmission of a Msg3. For another example, when the common PDCCH is a PDCCH for scheduling a retransmission of a Msg3, the another channel may be one or more of an SSB, a SIB1 PDCCH/PDSCH, a PRACH, a MsgA PRACH/PUSCH, a Msg2 PDCCH/PDSCH, and a Msg3. For another example, when the common PDCCH is a paging PDCCH, the another channel may be one or more of an SSB, a SIB1 PDCCH/PDSCH, a PRACH, a MsgA PRACH/PUSCH, a Msg2 PDCCH/PDSCH, a Msg3, a PDCCH for scheduling a retransmission of a Msg3, a Msg4 PDCCH/PDSCH, and a PUCCH for HARQ feedback of a Msg4.

When there is a collision with the another channel, the common PDCCH repetition is prioritized and the another channel is discarded. For example, when the common PDCCH is a SIB1 PDCCH, the another channel may be one or more of another PDCCH, another (non-SIB1) PDSCH, a PRACH, and a common PUSCH. For another example, when the common PDCCH is a Msg2 PDCCH, a Msg4 PDCCH, or a MsgB PDCCH, the another channel may be one or more of a PDCCH other than a SIB1 PDCCH, a PDSCH other than a SIB1 PDSCH, a common PUSCH, and a dedicated PUCCH.

When there is a collision with the another channel, whether to discard the common PDCCH repetition depends on one or more of the following rules:
whether a transmission is a 1^{st} common PDCCH repetition transmission, prioritize the 1^{st} common PDCCH repetition;
define a priority of a collision channel (the priority may be configured by the network or pre-specified in the protocol), and determine, according to the priority, a specific channel to be dropped; for example, the priority: the 1^{st} transmission of the common PDCCH repetition>a transmission other than the 1^{st} transmission of the common PDCCH repetition>another PDCCH>a PDSCH; and
in a case of a same priority, prioritize transmission with earlier generation time (timing).

In some embodiments, the slot for the common PDCCH repetition transmission is determined based on available slots, and only the available slots are used for a PDCCH repetition.

Further, for an inter-slot repetition transmission, only these available slots are counted in the configured quantity of repetitions.

In some embodiments, the available slot for the common PDCCH repetition is determined based on at least one of the following manners:
a symbol on which the common PDCCH is located does not overlap an SSB;
a symbol on which the common PDCCH is located does not overlap a PRACH;
a symbol on which the common PDCCH is located does not overlap a MsgA PUSCH;
a symbol on which the common PDCCH is located does not overlap another search space;
a symbol on which the common PDCCH is located does not overlap another CORESET;
a symbol on which the common PDCCH is located does not overlap a common PDCCH;
a symbol on which the common PDCCH is located is downlink symbols, for example, the DL symbols are determined based on a time division duplex-uplink-downlink common configuration (TDD-UL-DL-ConfigCommon); and
a symbol on which the common PDCCH is located is a flexible symbol.

In some embodiments, the PDCCH occasion for the common PDCCH repetition transmission is determined based on the available occasion, and only the available occasion is used for a PDCCH repetition.

Further, for an inter-occasion repetition transmission, only these available occasions are counted in the configured quantity of repetitions.

In some embodiments, the available slot for the common PDCCH repetition is determined based on at least one of the following manners:
a symbol of an occasion on which the common PDCCH is located does not overlap an SSB;
a symbol of an occasion on which the common PDCCH is located does not overlap a PRACH;
a symbol of an occasion on which the common PDCCH is located does not overlap a MsgA PUSCH;
a symbol of an occasion on which the common PDCCH is located does not overlap another search space;
a symbol of an occasion on which the common PDCCH is located does not overlap another CORESET;
a symbol of an occasion on which the common PDCCH is located does not overlap a common PDCCH;
a symbol of an occasion on which the common PDCCH is located is downlink symbols, for example, the DL symbols are determined based on TDD-UL-DL-ConfigCommon; and
a symbol of an occasion on which the common PDCCH is located is flexible symbols, and does not overlap an SSB and a PRACH.

In some embodiments, the common PDCCH repetition based on the available slot/available occasion or the physical slot/physical occasion may be determined based on one or more of the following manners:
indicated by system information (MIB or SIB);
indicated by an SSB;
indicated by a PDCCH resource configuration table specified by a MIB;
indicated by a specific CORESET, search space, or PDCCH MO; and
indicated by different PRACH resources/formats.

In some embodiments, the slot/occasion used for the common PDCCH repetition meets one or more of the following rules:
the slot/occasion for the 1^{st} common PDCCH repetition needs to be an available slot or an unavailable slot;
the slot/occasion for the common PDCCH repetition needs to be an available slot/occasion;
the slot/occasion for the common PDCCH repetition needs to be a physical slot/occasion; and
the slot/occasion for the common PDCCH repetition may be an available slot/occasion or may be a physical slot/occasion.

In some embodiments, the slot/occasion for the common PDCCH repetition is related to the SSB. A relationship between the slot/occasion for the common PDCCH repetition and the SSB includes one or more of the following:
In a case that the common PDCCH repetition is associated with a same SSB (each repetition is QCLed with the same SSB), a resource position including the slot/occasion for the common PDCCH repetition is related to a transmission moment of the SSB of the same beam. For example, the common PDCCH repetition is associated with SSB transmission of a beam #1. In this case, a resource for each common PDCCH repetition transmission may be obtained through an SSB of the beam #1. For example, a fixed offset is present.

In a case that the common PDCCH repetition is associated with different SSBs (each repetition is QCLed with a different SSB), a resource position including the slot/occasion for the common PDCCH repetition is related to transmission moments of SSBs of different beams. For example, a resource for each transmission of the common PDCCH repetition is determined respectively relative to transmission moments of an SSB of a beam #1, an SSB of a beam #2, an SSB of a beam #3. . . For example, there is a one-to-one correspondence.

### Embodiment 2

This embodiment mainly describes a transmission characteristic of a common PDCCH repetition. Details are as follows:

In some embodiments, the transmission characteristic of the common PDCCH repetition transmission is determined. The transmission characteristic includes at least one of the following:
an average power, an average delay, delay spread, Doppler frequency shift, Doppler spread, a spatial Rx parameter, and a beam corresponding to a transmission.

In some embodiments, transmission characteristics of different common PDCCH repetition transmissions are the same, for example:

The PDCCH repetition or its DMRS antenna port is quasi co-located with at least one of multiple downlink reference signals, where the downlink reference signal includes an SSB and/or a CSI-RS. The SSB includes at least one of the following:
an SSB and/or a CSI-RS associated with a PDCCH sent repeatedly;
an SSB and/or a CSI-RS associated with a corresponding PRACH;
an SSB and/or a CSI-RS associated with a CORESET #0 in which a PDCCH is located;
all SSBs sent by a serving cell; and
one of downlink reference signals associated with a related PRACH repetition transmission, for example, the first one or the last one.

In some embodiments, transmission characteristics of different common PDCCH repetition transmissions may be different, for example:

A transmission (such as a 1^{st} transmission) of the common PDCCH repetition or a DMRS antenna port of this PDCCH is quasi co-located with at least one of multiple downlink reference signals, where the downlink reference signal includes an SSB and/or a CSI-RS, and the SSB and/or the CSI-RS include/includes at least one of the following:
an SSB and/or a CSI-RS associated with a PDCCH sent repeatedly;
an SSB and/or a CSI-RS associated with a corresponding PRACH;
an SSB and/or a CSI-RS associated with a CORESET #0 in which a PDCCH is located;
all SSBs sent by a serving cell; and
one of downlink reference signals associated with a related PRACH repetition transmission, for example, the first one or the last one.

Determining of a beam for another transmission of the common PDCCH repetition includes at least one of the following:
obtained by adding a fixed angle to a beam for a most recent common PDCCH repetition transmission; and
a beam for a transmission of the common PDCCH repetition follows a predefined beam pattern.

Different beams for different transmissions of the common PDCCH repetition are narrow beams, and are narrower/finer beams divided from the downlink beam corresponding to the associated SSB. For example, the downlink beam corresponding to the associated SSB is a wide beam of 30 degrees. The narrow beam may refer to three narrow beams pointing at 30 degrees and 30±2 degrees.

In some embodiments, the common PDCCH repetition transmission has at least partially the same transmission characteristics as an SSB or CSI-RS resource corresponding to the PRACH resource used by the terminal.

In some embodiments, in a case that a repetition transmission is used for the PRACH resource used by the UE, a DMRS port for each repetition of the common PDCCH repetition transmission has at least partially the same transmission characteristics as an SSB or CSI-RS resource corresponding to each repetition of the PRACH resource used by the terminal. A PRACH repetition and a PDCCH repetition transmission use at least partially the same transmission characteristics according to a specific correspondence. For example, when a quantity of repetitions for the PRACH is the same as a quantity of repetitions for the PDCCH, both the PRACH and the PDCCH use at least partially the same transmission characteristics for their transmissions in a one-to-one correspondence.

The method for receiving a common PDCCH provided in the embodiments of this application may be performed by an apparatus for receiving a common PDCCH. In the embodiments of this application, the apparatus for receiving a common PDCCH provided in the embodiments of this application is described by using an example in which the apparatus for receiving a common PDCCH performs the method for receiving a common PDCCH.

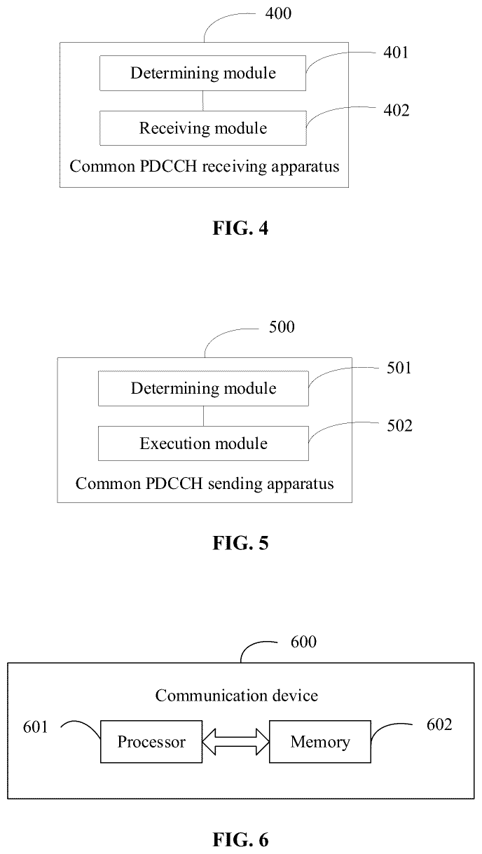

Referring to FIG. 4, FIG. 4 is a structural diagram of an apparatus for receiving a common PDCCH according to an embodiment of this application. As shown in FIG. 4, the apparatus 400 for receiving a common PDCCH includes:
a determining module 401, configured to determine a transmission resource or a transmission characteristic of a common PDCCH repetition transmission; and
a receiving module 402, configured to receive the common PDCCH repetition transmission based on the transmission resource or the transmission characteristic, where the common PDCCH includes at least one of the following:
a system information block SIB1 PDCCH, an other system information OSI PDCCH, a message 2 PDCCH, a message 4 PDCCH, a message B PDCCH, a paging PDCCH, and a PDCCH for scheduling a retransmission of a message 3.

Optionally, the transmission resource includes at least one of the following:
a slot and a monitoring occasion, where
the slot includes at least one of the following:
a physical slot and an available slot; and
the monitoring occasion includes at least one of the following:
a physical PDCCH monitoring occasion and an available PDCCH monitoring occasion.

Optionally, the physical slot includes consecutive physical slots; or
the physical PDCCH monitoring occasion includes consecutive physical PDCCH monitoring occasions.

Optionally, the consecutive physical slots belong to a same search space, and the consecutive physical slots are physical slots in which PDCCH monitoring occasions are located; or the consecutive physical slots belong to multiple search spaces, and the consecutive physical slots are physical slots in which PDCCH monitoring occasions are located; or
the consecutive physical PDCCH monitoring occasions belong to a same search space; or the consecutive physical PDCCH monitoring occasions belong to different search spaces.

Optionally, the available slot meets at least one of the following:
in the available slot, a symbol on which the common PDCCH repetition transmission is located does not overlap a symbol on which a synchronization signal block SSB is located;
in the available slot, a symbol on which the common PDCCH repetition transmission is located does not overlap a symbol on which a physical random access channel PRACH is located;
in the available slot, a symbol on which the common PDCCH repetition transmission is located does not overlap a symbol on which a message A physical uplink shared channel PUSCH is located;
in the available slot, a symbol on which the common PDCCH repetition transmission is located does not overlap a symbol corresponding to another search space, where the another search space is different from a search space corresponding to the common PDCCH repetition transmission;
in the available slot, a symbol on which the common PDCCH repetition transmission is located does not overlap a symbol corresponding to another control resource set CORESET, where the another CORESET is different from a CORESET corresponding to the common PDCCH repetition transmission;
in the available slot, a symbol on which the common PDCCH repetition transmission is located does not overlap a symbol on which another common PDCCH is located;
in the available slot, a symbol on which the common PDCCH repetition transmission is located is a downlink symbol; and
in the available slot, a symbol on which the common PDCCH repetition transmission is located is a flexible symbol.

Optionally, the available PDCCH monitoring occasion meets at least one of the following:
a symbol corresponding to the available PDCCH monitoring occasion does not overlap a symbol on which an SSB is located;
a symbol corresponding to the available PDCCH monitoring occasion does not overlap a symbol on which a PRACH is located;
a symbol corresponding to the available PDCCH monitoring occasion does not overlap a symbol on which a message A PUSCH is located;
a symbol corresponding to the available PDCCH monitoring occasion does not overlap a symbol corresponding to another search space, where the another search space is different from a search space corresponding to the common PDCCH repetition transmission;
a symbol corresponding to the available PDCCH monitoring occasion does not overlap a symbol corresponding to another control resource set CORESET, where the another CORESET is different from a CORESET corresponding to the common PDCCH repetition transmission;
a symbol corresponding to the available PDCCH monitoring occasion does not overlap a symbol on which another common PDCCH is located;
a symbol corresponding to the available PDCCH monitoring occasion is a downlink symbol; and
a symbol corresponding to the available PDCCH monitoring occasion is a flexible symbol.

Optionally, in a case that the common PDCCH repetition transmission is an inter-slot repetition transmission, a count of a quantity of repetitions for the common PDCCH repetition transmission includes at least one of the following:
a quantity of physical slots and a quantity of available slots; or
in a case that the common PDCCH repetition transmission is an inter-occasion repetition transmission, a count of a quantity of repetitions for the common PDCCH repetition transmission includes at least one of the following:
a quantity of physical PDCCH monitoring occasions and a quantity of available PDCCH monitoring occasions.

Optionally, the apparatus further includes:
a performing module, configured to: in a case that the transmission resource includes a collision slot in which the common PDCCH repetition transmission collides with another channel, perform first processing or second processing on the collision slot, where
the first processing includes: discarding receiving of the common PDCCH repetition transmission in the collision slot; and
the second processing includes: discarding receiving of the another channel in the collision slot.

Optionally, the performing first processing or second processing on the collision slot includes:
in a first case, performing the first processing on the collision slot, where the first case includes at least one of the following:
the common PDCCH includes a system information block SIB1 PDCCH, and the another channel includes an SSB;
the common PDCCH includes a message 2 PDCCH, and the another channel includes at least one of the following: an SSB, a SIB1 PDCCH, a SIB1 PDSCH, a PRACH, a message A PRACH, and a message A PUSCH;
the common PDCCH includes a message 4 PDCCH or a message B PDCCH, and the another channel includes at least one of the following: an SSB, a SIB1 PDCCH, a SIB1 PDSCH, a PRACH, a message A PRACH, a message A PUSCH, a message 2 PDCCH, a message 2 PDSCH, a message 3, and a PDCCH for scheduling a retransmission of a message 3;
the common PDCCH includes a PDCCH for scheduling a retransmission of a message 3, and the another channel includes at least one of the following: an SSB, a SIB1 PDCCH, a SIB1 PDSCH, a PRACH, a message A PRACH, a message A PUSCH, a message 2 PDCCH, a message 2 PDSCH, and a message 3; and
the common PDCCH includes a paging PDCCH, and the another channel includes at least one of the following: an SSB, a SIB1 PDCCH, a SIB1 PDSCH, a PRACH, a message A PRACH, a message A PUSCH, a message 2 PDCCH, a message 2 PDSCH, a message 3, a PDCCH for scheduling a retransmission of a message 3, a message 4 PDCCH, a message 4 PDSCH, and a physical uplink control channel PUCCH for hybrid automatic repeat request HARQ feedback of a message 4;
or
in a second case, performing the second processing on the collision slot, where the second case includes at least one of the following:
the common PDCCH includes a SIB1 PDCCH, and the another channel includes at least one of the following: another PDCCH, a non-SIB1 PDSCH, a PRACH, and a common PUSCH; and
the common PDCCH includes at least one of a message 2 PDCCH, a message 4 PDCCH, and a message B PDCCH, and the another channel includes at least one of the following:
a PDCCH other than a SIB1 PDCCH;
a PDSCH other than a SIB1 PDSCH;
a common PUSCH; and
a dedicated PUCCH.

Optionally, the performing first processing or second processing on the collision slot includes:
performing the first processing or the second processing on the collision slot according to any one of the following rules:
prioritizing a 1^{st} transmission of the common PDCCH repetition transmission;
prioritizing transmission of a channel with a high priority; and
in a case of a same priority, prioritizing transmission of a channel with earlier generation time.

Optionally, the transmission resource includes at least one of the following indicated transmission resources:
a transmission resource indicated by system information;
a transmission resource indicated by an SSB;
a transmission resource indicated by a PDCCH resource configuration table;
a transmission resource indicated by a CORESET;
a transmission resource indicated by a search space;
a transmission resource indicated by a PDCCH monitoring occasion;
a transmission resource indicated by a PRACH resource;
a transmission resource indicated by a PRACH format; and
a transmission resource indicated by a repetition count type.

Optionally, the transmission resource meets one of the following conditions:
a slot in which the 1^{st} transmission of the common PDCCH repetition transmission is located is an available slot;
a slot in which a transmission occasion of the 1^{st} transmission of the common PDCCH repetition transmission is located is an available slot;
a slot in which the common PDCCH repetition transmission is located is an available slot;
a transmission occasion of the common PDCCH repetition transmission is an available transmission occasion;
a slot in which the common PDCCH repetition transmission is located is a physical slot;
a transmission occasion of the common PDCCH repetition transmission is a physical transmission occasion;
a slot in which the common PDCCH repetition transmission is located is associated with an SSB; and
a transmission occasion of the common PDCCH repetition transmission is associated with an SSB.

Optionally, that a slot in which the common PDCCH repetition transmission is located is associated with an SSB includes at least one of the following:
in a case that each transmission of the common PDCCH repetition transmission is quasi co-located QCLed with a same SSB, a resource for each transmission of the common PDCCH repetition transmission is associated with transmission time of the SSB of a same beam; and
in a case that each transmission of the common PDCCH repetition transmission is QCLed with a different SSB, a resource for each transmission of the common PDCCH repetition transmission is associated with transmission time of the SSB of a different beam.

Optionally, in a case that transmission characteristics of different transmissions of the common PDCCH repetition transmission are the same, multiple transmissions of the common PDCCH repetition transmission are QCLed with at least one downlink reference signal, or a demodulation reference signal DMRS antenna port of the common PDCCH repetition transmission is QCLed with at least one downlink reference signal; or
in a case that transmission characteristics of different transmissions of the common PDCCH repetition transmission are different, an i^{th} transmission of the common PDCCH repetition transmission is QCLed with at least one downlink reference signal, or a DMRS antenna port of an i^{th} transmission of the common PDCCH repetition transmission is QCLed with at least one downlink reference signal, and a value of i is greater than or equal to 1 and less than or equal to a quantity of repetitions of the common PDCCH.

Optionally, the downlink reference signal includes at least one of the following:
a reference signal associated with a PDCCH sent repeatedly;
a reference signal associated with a PRACH;
a reference signal associated with a CORESET in which a PDCCH is located;
a reference signal sent by a serving cell; and
a reference signal associated with a PRACH repetition transmission, where
the reference signal includes an SSB or a CSI-RS.

Optionally, in a case that transmission characteristics of different transmissions of the common PDCCH repetition transmission are different, a beam of another transmission of the common PDCCH repetition transmission includes at least one of the following:
a beam determined by adding an angle offset to a beam for a transmission, of the common PDCCH repetition transmission, closest to the another transmission; and
a beam indicated by a beam pattern, where
the another transmission is a transmission different from the i^{th} transmission.

Optionally, in a case that the common PDCCH repetition transmission includes transmissions of different beams, the different beams are multiple beams divided from a downlink beam corresponding to an SSB associated with the common PDCCH repetition transmission.

Optionally, the transmission characteristic of the common PDCCH repetition transmission is at least partially the same as a transmission characteristic of a downlink reference signal resource corresponding to a PRACH resource used by the terminal.

Optionally, in a case that a repetition transmission is used for a PRACH used by the terminal, a transmission characteristic of an i^{th} transmission of the common PDCCH repetition transmission is at least partially the same as a transmission characteristic of an i^{th} transmission of the PRACH, and a value of i is greater than or equal to 1 and less than or equal to min {a maximum quantity of repetitions of the common PDCCH, a maximum quantity of repetitions of the PRACH}.

The apparatus for receiving a common PDCCH can improve network coverage performance.

The apparatus for receiving a common PDCCH in this embodiment of this application may be an electronic device, for example, an electronic device with an operating system, or may be a component in the electronic device, for example, an integrated circuit or a chip. For example, the electronic device may be a terminal, or another device other than the terminal. For example, the terminal may include but is not limited to the types of terminals listed in this embodiment of this application, and the another device may be a server, a network attached storage (NAS), or the like. This is not specifically limited in this embodiment of this application.

The apparatus for receiving a common PDCCH provided in this embodiment of this application can implement the processes implemented in the method embodiment shown in FIG. 2 and achieve a same technical effect. To avoid repetition, details are not described herein again.

The method for sending a common PDCCH provided in the embodiments of this application may be performed by an apparatus for sending a common PDCCH. In the embodiments of this application, the apparatus for sending a common PDCCH provided in the embodiments of this application is described by using an example in which the apparatus for sending a common PDCCH performs the method for sending a common PDCCH.

Referring to FIG. 5, FIG. 5 is a structural diagram of an apparatus for sending a common PDCCH according to an embodiment of this application. As shown in FIG. 5, the apparatus 500 for sending a common PDCCH includes:
a determining module 501, configured to determine a transmission resource or a transmission characteristic of a common PDCCH repetition transmission; and
a performing module 502, configured to perform the common PDCCH repetition transmission based on the transmission resource or the transmission characteristic, where
the common PDCCH includes at least one of the following:
a system information block SIB1 PDCCH, an other system information OSI PDCCH, a message 2 PDCCH, a message 4 PDCCH, a message B PDCCH, a paging PDCCH, and a PDCCH for scheduling a retransmission of a message 3.

Optionally, the transmission resource includes at least one of the following:
a slot and a monitoring occasion, where the slot includes at least one of the following:
a physical slot and an available slot; and
the monitoring occasion includes at least one of the following:
a physical PDCCH monitoring occasion and an available PDCCH monitoring occasion.

Optionally, the physical slot includes consecutive physical slots; or
the physical PDCCH monitoring occasion includes consecutive physical PDCCH monitoring occasions.

Optionally, the consecutive physical slots belong to a same search space, and the consecutive physical slots are physical slots in which PDCCH monitoring occasions are located; or the consecutive physical slots belong to multiple search spaces, and the consecutive physical slots are physical slots in which PDCCH monitoring occasions are located; or
the consecutive physical PDCCH monitoring occasions belong to a same search space; or the consecutive physical PDCCH monitoring occasions belong to different search spaces.

Optionally, the available slot meets at least one of the following:
in the available slot, a symbol on which the common PDCCH repetition transmission is located does not overlap a symbol on which a synchronization signal block SSB is located;
in the available slot, a symbol on which the common PDCCH repetition transmission is located does not overlap a symbol on which a physical random access channel PRACH is located;
in the available slot, a symbol on which the common PDCCH repetition transmission is located does not overlap a symbol on which a message A physical uplink shared channel PUSCH is located;
in the available slot, a symbol on which the common PDCCH repetition transmission is located does not overlap a symbol corresponding to another search space, where the another search space is different from a search space corresponding to the common PDCCH repetition transmission;
in the available slot, a symbol on which the common PDCCH repetition transmission is located does not overlap a symbol corresponding to another control resource set CORESET, where the another CORESET is different from a CORESET corresponding to the common PDCCH repetition transmission;
in the available slot, a symbol on which the common PDCCH repetition transmission is located does not overlap a symbol on which another common PDCCH is located;
in the available slot, a symbol on which the common PDCCH repetition transmission is located is a downlink symbol; and
in the available slot, a symbol on which the common PDCCH repetition transmission is located is a flexible symbol.

Optionally, the available PDCCH monitoring occasion meets at least one of the following:
a symbol corresponding to the available PDCCH monitoring occasion does not overlap a symbol on which an SSB is located;
a symbol corresponding to the available PDCCH monitoring occasion does not overlap a symbol on which a PRACH is located;
a symbol corresponding to the available PDCCH monitoring occasion does not overlap a symbol on which a message A PUSCH is located;
a symbol corresponding to the available PDCCH monitoring occasion does not overlap a symbol corresponding to another search space, where the another search space is different from a search space corresponding to the common PDCCH repetition transmission;
a symbol corresponding to the available PDCCH monitoring occasion does not overlap a symbol corresponding to another control resource set CORESET, where the another CORESET is different from a CORESET corresponding to the common PDCCH repetition transmission;
a symbol corresponding to the available PDCCH monitoring occasion does not overlap a symbol on which another common PDCCH is located;
a symbol corresponding to the available PDCCH monitoring occasion is a downlink symbol; and
a symbol corresponding to the available PDCCH monitoring occasion is a flexible symbol.

Optionally, in a case that the common PDCCH repetition transmission is an inter-slot repetition transmission, a count of a quantity of repetitions for the common PDCCH repetition transmission includes at least one of the following:
a quantity of physical slots and a quantity of available slots;
or
in a case that the common PDCCH repetition transmission is an inter-occasion repetition transmission, a count of a quantity of repetitions for the common PDCCH repetition transmission includes at least one of the following:
a quantity of physical PDCCH monitoring occasions and a quantity of available PDCCH monitoring occasions.

Optionally, the apparatus further includes:
a discarding module, configured to: in a case that the transmission resource includes a collision slot in which the common PDCCH repetition transmission collides with another channel, perform first processing or second processing on the collision slot, where
the first processing includes: discarding the common PDCCH repetition transmission in the collision slot; and
the second processing includes: discarding the another channel in the collision slot.

Optionally, the performing first processing or second processing on the collision slot includes:
in a first case, performing the first processing on the collision slot, where the first case includes at least one of the following:
the common PDCCH includes a system information block SIB1 PDCCH, and the another channel includes an SSB;
the common PDCCH includes a message 2 PDCCH, and the another channel includes at least one of the following: an SSB, a SIB1 PDCCH, a SIB1 PDSCH, a PRACH, a message A PRACH, and a message A PUSCH;
the common PDCCH includes a message 4 PDCCH or a message B PDCCH, and the another channel includes at least one of the following: an SSB, a SIB1 PDCCH, a SIB1 PDSCH, a PRACH, a message A PRACH, a message A PUSCH, a message 2 PDCCH, a message 2 PDSCH, a message 3, and a PDCCH for scheduling a retransmission of a message 3;
the common PDCCH includes a PDCCH for scheduling a retransmission of a message 3, and the another channel includes at least one of the following: an SSB, a SIB1 PDCCH, a SIB1 PDSCH, a PRACH, a message A PRACH, a message A PUSCH, a message 2 PDCCH, a message 2 PDSCH, and a message 3; and
the common PDCCH includes a paging PDCCH, and the another channel includes at least one of the following: an SSB, a SIB1 PDCCH, a SIB1 PDSCH, a PRACH, a message A PRACH, a message A PUSCH, a message 2 PDCCH, a message 2 PDSCH, a message 3, a PDCCH for scheduling a retransmission of a message 3, a message 4 PDCCH, a message 4 PDSCH, and a physical uplink control channel PUCCH for hybrid automatic repeat request HARQ feedback of a message 4;
or
in a second case, performing the second processing on the collision slot, where the second case includes at least one of the following:
the common PDCCH includes a SIB1 PDCCH, and the another channel includes at least one of the following: another PDCCH, a non-SIB1 PDSCH, a PRACH, and a common PUSCH; and
the common PDCCH includes at least one of a message 2 PDCCH, a message 4 PDCCH, and a message B PDCCH, and the another channel includes at least one of the following:
a PDCCH other than a SIB1 PDCCH;
a PDSCH other than a SIB1 PDSCH;
a common PUSCH; and
a dedicated PUCCH.

Optionally, the performing first processing or second processing on the collision slot includes:
performing the first processing or the second processing on the collision slot according to any one of the following rules:
prioritizing a 1^{st} transmission of the common PDCCH repetition transmission;
prioritizing transmission of a channel with a high priority; and
in a case of a same priority, prioritizing transmission of a channel with earlier generation time.

Optionally, the transmission resource includes at least one of the following indicated transmission resources:
a transmission resource indicated by system information;
a transmission resource indicated by an SSB;
a transmission resource indicated by a PDCCH resource configuration table;
a transmission resource indicated by a CORESET;
a transmission resource indicated by a search space;
a transmission resource indicated by a PDCCH monitoring occasion;
a transmission resource indicated by a PRACH resource;
a transmission resource indicated by a PRACH format; and
a transmission resource indicated by a repetition count type.

Optionally, the transmission resource meets one of the following conditions:
a slot in which the 1^{st} transmission of the common PDCCH repetition transmission is located is an available slot;
a slot in which a transmission occasion of the 1^{st} transmission of the common PDCCH repetition transmission is located is an available slot;
a slot in which the common PDCCH repetition transmission is located is an available slot;
a transmission occasion of the common PDCCH repetition transmission is an available transmission occasion;
a slot in which the common PDCCH repetition transmission is located is a physical slot;
a transmission occasion of the common PDCCH repetition transmission is a physical transmission occasion;
a slot in which the common PDCCH repetition transmission is located is associated with an SSB; and
a transmission occasion of the common PDCCH repetition transmission is associated with an SSB.

Optionally, that a slot in which the common PDCCH repetition transmission is located is associated with an SSB includes at least one of the following:
in a case that each transmission of the common PDCCH repetition transmission is quasi co-located QCLed with a same SSB, a resource for each transmission of the common PDCCH repetition transmission is associated with transmission time of the SSB of a same beam; and
in a case that each transmission of the common PDCCH repetition transmission is QCLed with a different SSB, a resource for each transmission of the common PDCCH repetition transmission is associated with transmission time of the SSB of a different beam.

Optionally, in a case that transmission characteristics of different transmissions of the common PDCCH repetition transmission are the same, multiple transmissions of the common PDCCH repetition transmission are QCLed with at least one downlink reference signal, or a demodulation reference signal DMRS antenna port of the common PDCCH repetition transmission is QCLed with at least one downlink reference signal;
or
in a case that transmission characteristics of different transmissions of the common PDCCH repetition transmission are different, an i^{th} transmission of the common PDCCH repetition transmission is QCLed with at least one downlink reference signal, or a DMRS antenna port of an i^{th} transmission of the common PDCCH repetition transmission is QCLed with at least one downlink reference signal, and a value of i is greater than or equal to 1 and less than or equal to a quantity of repetitions of the common PDCCH.

Optionally, the downlink reference signal includes at least one of the following:
a reference signal associated with a PDCCH sent repeatedly;
a reference signal associated with a PRACH;
a reference signal associated with a CORESET in which a PDCCH is located;
a reference signal sent by a serving cell; and
a reference signal associated with a PRACH repetition transmission, where
the reference signal includes an SSB or a CSI-RS.

Optionally, in a case that transmission characteristics of different transmissions of the common PDCCH repetition transmission are different, a beam of another transmission of the common PDCCH repetition transmission includes at least one of the following:
a beam determined by adding an angle offset to a beam for a transmission, of the common PDCCH repetition transmission, closest to the another transmission; and
a beam indicated by a beam pattern, where
the another transmission is a transmission different from the i^{th} transmission.

Optionally, in a case that the common PDCCH repetition transmission includes transmissions of different beams, the different beams are multiple beams divided from a downlink beam corresponding to an SSB associated with the common PDCCH repetition transmission.

Optionally, the transmission characteristic of the common PDCCH repetition transmission is at least partially the same as a transmission characteristic of a downlink reference signal resource corresponding to a PRACH resource used by the terminal.

Optionally, in a case that a repetition transmission is used for a PRACH used by the terminal, a transmission characteristic of an i^{th} transmission of the common PDCCH repetition transmission is at least partially the same as a transmission characteristic of an i^{th} transmission of the PRACH, and a value of i is greater than or equal to 1 and less than or equal to min{a maximum quantity of repetitions of the common PDCCH, a maximum quantity of repetitions of the PRACH}.

The apparatus for sending a common PDCCH can improve network coverage performance.

The apparatus for sending a common PDCCH in this embodiment of this application may be an electronic device, for example, an electronic device with an operating system, or may be a component in the electronic device, for example, an integrated circuit or a chip. The electronic device may be a terminal or a network side device.

The apparatus for sending a common PDCCH provided in this embodiment of this application can implement the processes implemented in the method embodiment shown in FIG. 3, and achieve a same technical effect. To avoid repetition, details are not provided herein again.

Optionally, as shown in FIG. 6, an embodiment of this application further provides a communication device 600, including a processor 601 and a memory 602. The memory 602 stores a program or an instruction that is executable on the processor 601. For example, when the communication device 600 is a terminal, the program or the instruction is executed by the processor 601 to implement the steps in the embodiment of the method for receiving a common PDCCH on a terminal side, and a same technical effect can be achieved. When the communication device 600 is a network side device, the program or the instruction is executed by the processor 601 to implement the steps in the embodiment of the method for sending a common PDCCH on a network side, and a same technical effect can be achieved. To avoid repetition, details are not described herein again.

An embodiment of this application further provides a terminal, including a processor and a communication interface. The processor is configured to determine a transmission resource or a transmission characteristic of a common PDCCH repetition transmission. The communication interface is configured to receive the common PDCCH repetition transmission based on the transmission resource or the transmission characteristic, where the common PDCCH includes at least one of the following: a system information block SIB1 PDCCH, an other system information OSI PDCCH, a message 2 PDCCH, a message 4 PDCCH, a message B PDCCH, a paging PDCCH, and a PDCCH for scheduling a retransmission of a message 3.

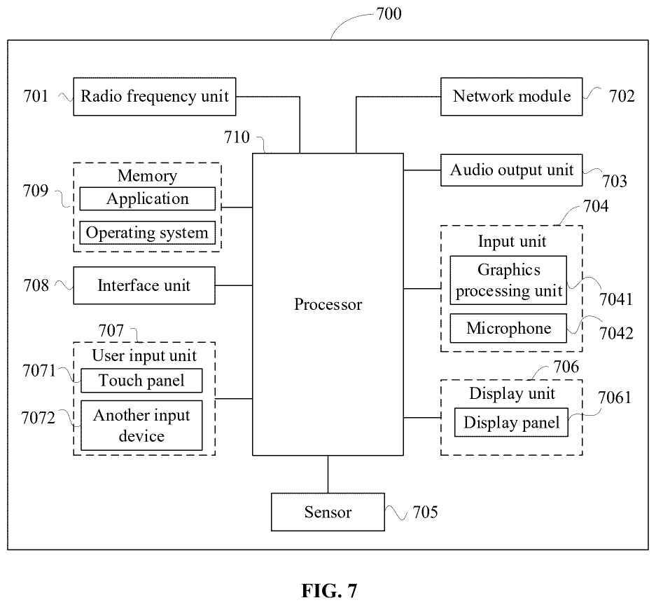

As shown in FIG. 7, the terminal 700 includes but is not limited to at least some components in: a radio frequency unit 701, a network module 702, an audio output unit 703, an input unit 704, a sensor 705, a display unit 706, a user input unit 707, an interface unit 708, a memory 709, and a processor 710.

A person skilled in the art can understand that the terminal 700 may further include a power supply (such as a battery) that supplies power to each component. The power supply may be logically connected to the processor 710 by using a power supply management system, to implement functions such as charging and discharging management, and power consumption management by using the power supply management system. The structure of the communications device shown in FIG. 7 does not constitute a limitation on the communications device. The communications device may include components more or fewer than those shown in the diagram, a combination of some components, or different component arrangements. Details are not described herein.

It should be understood that in this embodiment of this application, the input unit 704 may include a graphics processing unit (GPU) 7041 and a microphone 7042. The graphics processing unit 7041 processes image data of a static picture or a video obtained by an image capture apparatus (for example, a camera) in a video capture mode or an image capture mode. The display unit 706 may include a display panel 7061, and the display panel 7061 may be configured in a form of a liquid crystal display, an organic light-emitting diode, or the like. The user input unit 707 includes at least one of a touch panel 7071 and another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 701 may transmit the downlink data to the processor 710 for processing. In addition, the radio frequency unit 701 may send uplink data to the network side device. Generally, the radio frequency unit 701 includes but is not limited to an antenna, an amplifier, a transceiver, a coupler, a low noise amplifier, a duplexer, and the like.

The memory 709 may be configured to store a software program or an instruction and various data. The memory 709 may mainly include a first storage area for storing a program or an instruction and a second storage area for storing data. The first storage area may store an operating system, and an application or an instruction required by at least one function (for example, a sound playing function or an image playing function). In addition, the memory 709 may be a volatile memory or a non-volatile memory, or the memory 709 may include a volatile memory and a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 709 in this embodiment of this application includes but is not limited to these memories and any memory of another proper type.

The processor 710 may include one or more processing units. Optionally, an application processor and a modem processor are integrated into the processor 710. The application processor mainly processes an operating system, a user interface, an application, or the like. The modem processor mainly processes a wireless communication signal, for example, a baseband processor. It may be understood that, alternatively, the modem processor may not be integrated into the processor 710.

The processor 710 is configured to determine a transmission resource or a transmission characteristic of a common PDCCH repetition transmission.

The radio frequency unit 701 is configured to receive the common PDCCH repetition transmission based on the transmission resource or the transmission characteristic, where
the common PDCCH includes at least one of the following:
a system information block SIB1 PDCCH, an other system information OSI PDCCH, a message 2 PDCCH, a message 4 PDCCH, a message B PDCCH, a paging PDCCH, and a PDCCH for scheduling a retransmission of a message 3.

Optionally, the transmission resource includes at least one of the following:
a slot and a monitoring occasion, where
the slot includes at least one of the following:
a physical slot and an available slot; and
the monitoring occasion includes at least one of the following:
a physical PDCCH monitoring occasion and an available PDCCH monitoring occasion.
Optionally, the physical slot includes consecutive physical slots; or
the physical PDCCH monitoring occasion includes consecutive physical PDCCH monitoring occasions.

Optionally, the consecutive physical slots belong to a same search space, and the consecutive physical slots are physical slots in which PDCCH monitoring occasions are located; or the consecutive physical slots belong to multiple search spaces, and the consecutive physical slots are physical slots in which PDCCH monitoring occasions are located;
or
the consecutive physical PDCCH monitoring occasions belong to a same search space; or the consecutive physical PDCCH monitoring occasions belong to different search spaces.

Optionally, the available slot meets at least one of the following:
in the available slot, a symbol on which the common PDCCH repetition transmission is located does not overlap a symbol on which a synchronization signal block SSB is located;
in the available slot, a symbol on which the common PDCCH repetition transmission is located does not overlap a symbol on which a physical random access channel PRACH is located;
in the available slot, a symbol on which the common PDCCH repetition transmission is located does not overlap a symbol on which a message A physical uplink shared channel PUSCH is located;
in the available slot, a symbol on which the common PDCCH repetition transmission is located does not overlap a symbol corresponding to another search space, where the another search space is different from a search space corresponding to the common PDCCH repetition transmission;
in the available slot, a symbol on which the common PDCCH repetition transmission is located does not overlap a symbol corresponding to another control resource set CORESET, where the another CORESET is different from a CORESET corresponding to the common PDCCH repetition transmission;
in the available slot, a symbol on which the common PDCCH repetition transmission is located does not overlap a symbol on which another common PDCCH is located;
in the available slot, a symbol on which the common PDCCH repetition transmission is located is a downlink symbol; and
in the available slot, a symbol on which the common PDCCH repetition transmission is located is a flexible symbol.

Optionally, the available PDCCH monitoring occasion meets at least one of the following:
a symbol corresponding to the available PDCCH monitoring occasion does not overlap a symbol on which an SSB is located;
a symbol corresponding to the available PDCCH monitoring occasion does not overlap a symbol on which a PRACH is located;
a symbol corresponding to the available PDCCH monitoring occasion does not overlap a symbol on which a message A PUSCH is located;
a symbol corresponding to the available PDCCH monitoring occasion does not overlap a symbol corresponding to another search space, where the another search space is different from a search space corresponding to the common PDCCH repetition transmission;
a symbol corresponding to the available PDCCH monitoring occasion does not overlap a symbol corresponding to another control resource set CORESET, where the another CORESET is different from a CORESET corresponding to the common PDCCH repetition transmission;
a symbol corresponding to the available PDCCH monitoring occasion does not overlap a symbol on which another common PDCCH is located;
a symbol corresponding to the available PDCCH monitoring occasion is a downlink symbol; and
a symbol corresponding to the available PDCCH monitoring occasion is a flexible symbol.

Optionally, in a case that the common PDCCH repetition transmission is an inter-slot repetition transmission, a count of a quantity of repetitions for the common PDCCH repetition transmission includes at least one of the following:
a quantity of physical slots and a quantity of available slots;
or
in a case that the common PDCCH repetition transmission is an inter-occasion repetition transmission, a count of a quantity of repetitions for the common PDCCH repetition transmission includes at least one of the following:
a quantity of physical PDCCH monitoring occasions and a quantity of available PDCCH monitoring occasions.

Optionally, the processor 710 is further configured to: in a case that the transmission resource includes a collision slot in which the common PDCCH repetition transmission collides with another channel, perform first processing or second processing on the collision slot, where
the first processing includes: discarding receiving of the common PDCCH repetition transmission in the collision slot; and
the second processing includes: discarding receiving of the another channel in the collision slot.

Optionally, the performing first processing or second processing on the collision slot includes:
in a first case, performing the first processing on the collision slot, where the first case includes at least one of the following:
the common PDCCH includes a system information block SIB1 PDCCH, and the another channel includes an SSB;
the common PDCCH includes a message 2 PDCCH, and the another channel includes at least one of the following: an SSB, a SIB1 PDCCH, a SIB1 PDSCH, a PRACH, a message A PRACH, and a message A PUSCH;
the common PDCCH includes a message 4 PDCCH or a message B PDCCH, and the another channel includes at least one of the following: an SSB, a SIB1 PDCCH, a SIB1 PDSCH, a PRACH, a message A PRACH, a message A PUSCH, a message 2 PDCCH, a message 2 PDSCH, a message 3, and a PDCCH for scheduling a retransmission of a message 3;
the common PDCCH includes a PDCCH for scheduling a retransmission of a message 3, and the another channel includes at least one of the following: an SSB, a SIB1 PDCCH, a SIB1 PDSCH, a PRACH, a message A PRACH, a message A PUSCH, a message 2 PDCCH, a message 2 PDSCH, and a message 3; and
the common PDCCH includes a paging PDCCH, and the another channel includes at least one of the following: an SSB, a SIB1 PDCCH, a SIB1 PDSCH, a PRACH, a message A PRACH, a message A PUSCH, a message 2 PDCCH, a message 2 PDSCH, a message 3, a PDCCH for scheduling a retransmission of a message 3, a message 4 PDCCH, a message 4 PDSCH, and a physical uplink control channel PUCCH for hybrid automatic repeat request HARQ feedback of a message 4;
or
in a second case, performing the second processing on the collision slot, where the second case includes at least one of the following:
the common PDCCH includes a SIB1 PDCCH, and the another channel includes at least one of the following: another PDCCH, a non-SIB1 PDSCH, a PRACH, and a common PUSCH; and
the common PDCCH includes at least one of a message 2 PDCCH, a message 4 PDCCH, and a message B PDCCH, and the another channel includes at least one of the following:
a PDCCH other than a SIB1 PDCCH;
a PDSCH other than a SIB1 PDSCH;
a common PUSCH; and
a dedicated PUCCH.

Optionally, the performing first processing or second processing on the collision slot includes:
performing the first processing or the second processing on the collision slot according to any one of the following rules:
prioritizing a 1^{st} transmission of the common PDCCH repetition transmission;
prioritizing transmission of a channel with a high priority; and
in a case of a same priority, prioritizing transmission of a channel with earlier generation time.

Optionally, the transmission resource includes at least one of the following indicated transmission resources:
a transmission resource indicated by system information;
a transmission resource indicated by an SSB;
a transmission resource indicated by a PDCCH resource configuration table;
a transmission resource indicated by a CORESET;
a transmission resource indicated by a search space;
a transmission resource indicated by a PDCCH monitoring occasion;
a transmission resource indicated by a PRACH resource;
a transmission resource indicated by a PRACH format; and
a transmission resource indicated by a repetition count type.

Optionally, the transmission resource meets one of the following conditions:
a slot in which the 1^{st} transmission of the common PDCCH repetition transmission is located is an available slot;
a slot in which a transmission occasion of the 1^{st} transmission of the common PDCCH repetition transmission is located is an available slot;
a slot in which the common PDCCH repetition transmission is located is an available slot;
a transmission occasion of the common PDCCH repetition transmission is an available transmission occasion;
a slot in which the common PDCCH repetition transmission is located is a physical slot;
a transmission occasion of the common PDCCH repetition transmission is a physical transmission occasion;
a slot in which the common PDCCH repetition transmission is located is associated with an SSB; and
a transmission occasion of the common PDCCH repetition transmission is associated with an SSB.

Optionally, that a slot in which the common PDCCH repetition transmission is located is associated with an SSB includes at least one of the following:
in a case that each transmission of the common PDCCH repetition transmission is quasi co-located QCLed with a same SSB, a resource for each transmission of the common PDCCH repetition transmission is associated with transmission time of the SSB of a same beam; and
in a case that each transmission of the common PDCCH repetition transmission is QCLed with a different SSB, a resource for each transmission of the common PDCCH repetition transmission is associated with transmission time of the SSB of a different beam.

Optionally, in a case that transmission characteristics of different transmissions of the common PDCCH repetition transmission are the same, multiple transmissions of the common PDCCH repetition transmission are QCLed with at least one downlink reference signal, or a demodulation reference signal DMRS antenna port of the common PDCCH repetition transmission is QCLed with at least one downlink reference signal;
or
in a case that transmission characteristics of different transmissions of the common PDCCH repetition transmission are different, an i^{th} transmission of the common PDCCH repetition transmission is QCLed with at least one downlink reference signal, or a DMRS antenna port of an i^{th} transmission of the common PDCCH repetition transmission is QCLed with at least one downlink reference signal, and a value of i is greater than or equal to 1 and less than or equal to a quantity of repetitions of the common PDCCH.

Optionally, the downlink reference signal includes at least one of the following:
a reference signal associated with a PDCCH sent repeatedly;
a reference signal associated with a PRACH;
a reference signal associated with a CORESET in which a PDCCH is located;
a reference signal sent by a serving cell; and
a reference signal associated with a PRACH repetition transmission, where
the reference signal includes an SSB or a CSI-RS.

Optionally, in a case that transmission characteristics of different transmissions of the common PDCCH repetition transmission are different, a beam of another transmission of the common PDCCH repetition transmission includes at least one of the following:
a beam determined by adding an angle offset to a beam for a transmission, of the common PDCCH repetition transmission, closest to the another transmission; and
a beam indicated by a beam pattern, where
the another transmission is a transmission different from the i^{th} transmission.

Optionally, in a case that the common PDCCH repetition transmission includes transmissions of different beams, the different beams are multiple beams divided from a downlink beam corresponding to an SSB associated with the common PDCCH repetition transmission.

Optionally, the transmission characteristic of the common PDCCH repetition transmission is at least partially the same as a transmission characteristic of a downlink reference signal resource corresponding to a PRACH resource used by the terminal.

Optionally, in a case that a repetition transmission is used for a PRACH used by the terminal, a transmission characteristic of an i^{th} transmission of the common PDCCH repetition transmission is at least partially the same as a transmission characteristic of an i^{th} transmission of the PRACH, and a value of i is greater than or equal to 1 and less than or equal to min{a maximum quantity of repetitions of the common PDCCH, a maximum quantity of repetitions of the PRACH}.

The terminal can improve network coverage performance.

It may be understood that for the implementation processes of the implementations mentioned in this embodiment, refer to the related descriptions of the method embodiments. A same or corresponding technical effect is achieved. To avoid repetition, details are not described herein again.

An embodiment of this application further provides a network side device, including a processor and a communication interface. The processor is configured to determine a transmission resource or a transmission characteristic of a common PDCCH repetition transmission. The communication interface is configured to perform the common PDCCH repetition transmission based on the transmission resource or the transmission characteristic, where the common PDCCH includes at least one of the following: a system information block SIB1 PDCCH, an other system information OSI PDCCH, a message 2 PDCCH, a message 4 PDCCH, a message B PDCCH, a paging PDCCH, and a PDCCH for scheduling a retransmission of a message 3.

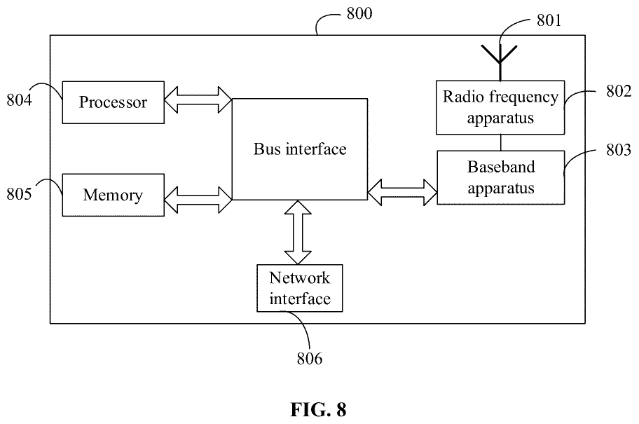

As shown in FIG. 8, the network side device 800 includes an antenna 801, a radio frequency apparatus 802, a baseband apparatus 803, a processor 804, and a memory 805. The antenna 801 is connected to the radio frequency apparatus 802. In an uplink direction, the radio frequency apparatus 802 receives information through the antenna 801, and sends the received information to the baseband apparatus 803 for processing. In a downlink direction, the baseband apparatus 803 processes information that needs to be sent, and sends processed information to the radio frequency apparatus 802. The radio frequency apparatus 802 processes the received information, and sends processed information through the antenna 801.

In the foregoing embodiment, the method performed by the radio access network device may be implemented in the baseband apparatus 803. The baseband apparatus 803 includes a baseband processor.

For example, the baseband apparatus 803 may include at least one baseband board. A plurality of chips are disposed on the baseband board. As shown in FIG. 8, one chip is, for example, a baseband processor, and is connected to the memory 805 by using a bus interface, to invoke a program in the memory 805 to perform the operations of the network device shown in the foregoing method embodiment.

The radio access network device may further include a network interface 806, and the interface is, for example, a common public radio interface (CPRI).

Specifically, the network side device 800 in this embodiment of this application further includes an instruction or a program that is stored in the memory 805 and that is executable on the processor 804. The processor 804 invokes the instruction or the program in the memory 805 to execute the method executed by the modules shown in FIG. 5, and a same technical effect is achieved. To avoid repetition, details are not described herein again.

The processor 804 is configured to determine a transmission resource or a transmission characteristic of a common PDCCH repetition transmission.

The radio frequency apparatus 802 is configured to perform the common PDCCH repetition transmission based on the transmission resource or the transmission characteristic.

Optionally, the transmission resource includes at least one of the following:
a slot and a monitoring occasion, where
the slot includes at least one of the following:
a physical slot and an available slot; and
the monitoring occasion includes at least one of the following:
a physical PDCCH monitoring occasion and an available PDCCH monitoring occasion.

Optionally, the physical slot includes consecutive physical slots; or
the physical PDCCH monitoring occasion includes consecutive physical PDCCH monitoring occasions.

Optionally, the consecutive physical slots belong to a same search space, and the consecutive physical slots are physical slots in which PDCCH monitoring occasions are located; or the consecutive physical slots belong to multiple search spaces, and the consecutive physical slots are physical slots in which PDCCH monitoring occasions are located;
or
the consecutive physical PDCCH monitoring occasions belong to a same search space; or the consecutive physical PDCCH monitoring occasions belong to different search spaces.

Optionally, the available slot meets at least one of the following:
in the available slot, a symbol on which the common PDCCH repetition transmission is located does not overlap a symbol on which a synchronization signal block SSB is located;
in the available slot, a symbol on which the common PDCCH repetition transmission is located does not overlap a symbol on which a physical random access channel PRACH is located;
in the available slot, a symbol on which the common PDCCH repetition transmission is located does not overlap a symbol on which a message A physical uplink shared channel PUSCH is located;
in the available slot, a symbol on which the common PDCCH repetition transmission is located does not overlap a symbol corresponding to another search space, where the another search space is different from a search space corresponding to the common PDCCH repetition transmission;
in the available slot, a symbol on which the common PDCCH repetition transmission is located does not overlap a symbol corresponding to another control resource set CORESET, where the another CORESET is different from a CORESET corresponding to the common PDCCH repetition transmission;
in the available slot, a symbol on which the common PDCCH repetition transmission is located does not overlap a symbol on which another common PDCCH is located;
in the available slot, a symbol on which the common PDCCH repetition transmission is located is a downlink symbol; and
in the available slot, a symbol on which the common PDCCH repetition transmission is located is a flexible symbol.

Optionally, the available PDCCH monitoring occasion meets at least one of the following:
a symbol corresponding to the available PDCCH monitoring occasion does not overlap a symbol on which an SSB is located;
a symbol corresponding to the available PDCCH monitoring occasion does not overlap a symbol on which a PRACH is located;
a symbol corresponding to the available PDCCH monitoring occasion does not overlap a symbol on which a message A PUSCH is located;
a symbol corresponding to the available PDCCH monitoring occasion does not overlap a symbol corresponding to another search space, where the another search space is different from a search space corresponding to the common PDCCH repetition transmission;
a symbol corresponding to the available PDCCH monitoring occasion does not overlap a symbol corresponding to another control resource set CORESET, where the another CORESET is different from a CORESET corresponding to the common PDCCH repetition transmission;
a symbol corresponding to the available PDCCH monitoring occasion does not overlap a symbol on which another common PDCCH is located;
a symbol corresponding to the available PDCCH monitoring occasion is a downlink symbol; and
a symbol corresponding to the available PDCCH monitoring occasion is a flexible symbol.

Optionally, in a case that the common PDCCH repetition transmission is an inter-slot repetition transmission, a count of a quantity of repetitions for the common PDCCH repetition transmission includes at least one of the following:
a quantity of physical slots and a quantity of available slots;
or
in a case that the common PDCCH repetition transmission is an inter-occasion repetition transmission, a count of a quantity of repetitions for the common PDCCH repetition transmission includes at least one of the following:
a quantity of physical PDCCH monitoring occasions and a quantity of available PDCCH monitoring occasions.

Optionally, the processor 804 is further configured to:
in a case that the transmission resource includes a collision slot in which the common PDCCH repetition transmission collides with another channel, performing first processing or second processing on the collision slot, where
the first processing includes: discarding the common PDCCH repetition transmission in the collision slot; and
the second processing includes: discarding the another channel in the collision slot.

Optionally, the performing first processing or second processing on the collision slot includes:
in a first case, performing the first processing on the collision slot, where the first case includes at least one of the following:
the common PDCCH includes a system information block SIB1 PDCCH, and the another channel includes an SSB;
the common PDCCH includes a message 2 PDCCH, and the another channel includes at least one of the following: an SSB, a SIB1 PDCCH, a SIB1 PDSCH, a PRACH, a message A PRACH, and a message A PUSCH;
the common PDCCH includes a message 4 PDCCH or a message B PDCCH, and the another channel includes at least one of the following: an SSB, a SIB1 PDCCH, a SIB1 PDSCH, a PRACH, a message A PRACH, a message A PUSCH, a message 2 PDCCH, a message 2 PDSCH, a message 3, and a PDCCH for scheduling a retransmission of a message 3;
the common PDCCH includes a PDCCH for scheduling a retransmission of a message 3, and the another channel includes at least one of the following: an SSB, a SIB1 PDCCH, a SIB1 PDSCH, a PRACH, a message A PRACH, a message A PUSCH, a message 2 PDCCH, a message 2 PDSCH, and a message 3; and
the common PDCCH includes a paging PDCCH, and the another channel includes at least one of the following: an SSB, a SIB1 PDCCH, a SIB1 PDSCH, a PRACH, a message A PRACH, a message A PUSCH, a message 2 PDCCH, a message 2 PDSCH, a message 3, a PDCCH for scheduling a retransmission of a message 3, a message 4 PDCCH, a message 4 PDSCH, and a physical uplink control channel PUCCH for hybrid automatic repeat request HARQ feedback of a message 4;
or
in a second case, performing the second processing on the collision slot, where the second case includes at least one of the following:
the common PDCCH includes a SIB1 PDCCH, and the another channel includes at least one of the following: another PDCCH, a non-SIB1 PDSCH, a PRACH, and a common PUSCH; and
the common PDCCH includes at least one of a message 2 PDCCH, a message 4 PDCCH, and a message B PDCCH, and the another channel includes at least one of the following:
a PDCCH other than a SIB1 PDCCH;
a PDSCH other than a SIB1 PDSCH;
a common PUSCH; and
a dedicated PUCCH.

Optionally, the performing first processing or second processing on the collision slot includes:
performing the first processing or the second processing on the collision slot according to any one of the following rules:
prioritizing a 1^{st} transmission of the common PDCCH repetition transmission;
prioritizing transmission of a channel with a high priority; and
in a case of a same priority, prioritizing transmission of a channel with earlier generation time.

Optionally, the transmission resource includes at least one of the following indicated transmission resources:
a transmission resource indicated by system information;
a transmission resource indicated by an SSB;
a transmission resource indicated by a PDCCH resource configuration table;
a transmission resource indicated by a CORESET;
a transmission resource indicated by a search space;
a transmission resource indicated by a PDCCH monitoring occasion;
a transmission resource indicated by a PRACH resource;
a transmission resource indicated by a PRACH format; and
a transmission resource indicated by a repetition count type.

Optionally, the transmission resource meets one of the following conditions:
a slot in which the 1^{st} transmission of the common PDCCH repetition transmission is located is an available slot;
a slot in which a transmission occasion of the 1^{st} transmission of the common PDCCH repetition transmission is located is an available slot;
a slot in which the common PDCCH repetition transmission is located is an available slot;
a transmission occasion of the common PDCCH repetition transmission is an available transmission occasion;
a slot in which the common PDCCH repetition transmission is located is a physical slot;
a transmission occasion of the common PDCCH repetition transmission is a physical transmission occasion;
a slot in which the common PDCCH repetition transmission is located is associated with an SSB; and
a transmission occasion of the common PDCCH repetition transmission is associated with an SSB.

Optionally, that a slot in which the common PDCCH repetition transmission is located is associated with an SSB includes at least one of the following:
in a case that each transmission of the common PDCCH repetition transmission is quasi co-located QCLed with a same SSB, a resource for each transmission of the common PDCCH repetition transmission is associated with transmission time of the SSB of a same beam; and
in a case that each transmission of the common PDCCH repetition transmission is QCLed with a different SSB, a resource for each transmission of the common PDCCH repetition transmission is associated with transmission time of the SSB of a different beam.

Optionally, in a case that transmission characteristics of different transmissions of the common PDCCH repetition transmission are the same, multiple transmissions of the common PDCCH repetition transmission are QCLed with at least one downlink reference signal, or a demodulation reference signal DMRS antenna port of the common PDCCH repetition transmission is QCLed with at least one downlink reference signal;
or
in a case that transmission characteristics of different transmissions of the common PDCCH repetition transmission are different, an i^{th} transmission of the common PDCCH repetition transmission is QCLed with at least one downlink reference signal, or a DMRS antenna port of an i^{th} transmission of the common PDCCH repetition transmission is QCLed with at least one downlink reference signal, and a value of i is greater than or equal to 1 and less than or equal to a quantity of repetitions of the common PDCCH.

Optionally, the downlink reference signal includes at least one of the following:
a reference signal associated with a PDCCH sent repeatedly;
a reference signal associated with a PRACH;
a reference signal associated with a CORESET in which a PDCCH is located;
a reference signal sent by a serving cell; and
a reference signal associated with a PRACH repetition transmission, where
the reference signal includes an SSB or a CSI-RS.

Optionally, in a case that transmission characteristics of different transmissions of the common PDCCH repetition transmission are different, a beam of another transmission of the common PDCCH repetition transmission includes at least one of the following:
a beam determined by adding an angle offset to a beam for a transmission, of the common PDCCH repetition transmission, closest to the another transmission; and
a beam indicated by a beam pattern, where
the another transmission is a transmission different from the i^{th} transmission.

Optionally, in a case that the common PDCCH repetition transmission includes transmissions of different beams, the different beams are multiple beams divided from a downlink beam corresponding to an SSB associated with the common PDCCH repetition transmission.

Optionally, the transmission characteristic of the common PDCCH repetition transmission is at least partially the same as a transmission characteristic of a downlink reference signal resource corresponding to a PRACH resource used by the terminal.

Optionally, in a case that a repetition transmission is used for a PRACH used by the terminal, a transmission characteristic of an i^{th} transmission of the common PDCCH repetition transmission is at least partially the same as a transmission characteristic of an i^{th} transmission of the PRACH, and a value of i is greater than or equal to 1 and less than or equal to min{a maximum quantity of repetitions of the common PDCCH, a maximum quantity of repetitions of the PRACH}.

The network side device can improve network coverage performance.

An embodiment of this application further provides a readable storage medium. The readable storage medium stores a program or an instruction, and the program or the instruction is executed by a processor to implement the processes of the embodiment of the method for receiving a common PDCCH or the method for sending a common PDCCH, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc. In some examples, the readable storage medium may be a non-transitory readable storage medium.

An embodiment of this application further provides a chip. The chip includes a processor and a communication interface, the communication interface is coupled to the processor, and the processor is configured to run a program or an instruction to implement the processes of the embodiment of the method for receiving a common PDCCH or the method for sending a common PDCCH, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the computer program/program product is executed by at least one processor to implement the processes of the embodiment of the method for receiving a common PDCCH or the method for sending a common PDCCH, and a same technical effect can be achieved. To avoid repetition, details are not described herein again.

An embodiment of this application further provides a wireless communication system, including a terminal and a network side device. The terminal may be configured to perform the steps of the method for receiving a common PDCCH provided in the embodiments of this application, and the network side device may be configured to perform the steps of the method for sending a common PDCCH provided in the embodiments of this application.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a. . .” does not preclude the existence of other identical elements in the process, method, article, or apparatus that includes the element. In addition, it should be noted that the scope of the method and apparatuses in the embodiments of this application is not limited to performing functions in the order shown or discussed, but may also include performing the functions in a basically simultaneous manner or in opposite order based on the functions involved. For example, the described method may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by a computer software product in addition to a necessary universal hardware platform or by hardware only. The computer software product is stored in a storage medium (such as a ROM, a RAM, a magnetic disk, or an optical disc), and includes several instructions for instructing a terminal or a network side device to perform the methods in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make implementations in many forms without departing from the purpose of this application and the protection scope of the claims, the implementations fall within the protection of this application.

What is claimed is:

1. A method for receiving a common physical downlink control channel (PDCCH), comprising:
determining, by a terminal, a transmission resource or a transmission characteristic of a common PDCCH repetition transmission; and
receiving, by the terminal, the common PDCCH repetition transmission based on the transmission resource or the transmission characteristic, wherein
the common PDCCH comprises at least one of the following:
a system information block (SIB1) PDCCH, an other system information (OSI) PDCCH, a message 2 PDCCH, a message 4 PDCCH, a message B PDCCH, a paging PDCCH, or a PDCCH for scheduling a retransmission of a message 3.

2. The method according to claim 1, wherein the transmission resource comprises at least one of the following:
a slot or a monitoring occasion, wherein
the slot comprises at least one of the following:
a physical slot or an available slot; and
the monitoring occasion comprises at least one of the following:
a physical PDCCH monitoring occasion or an available PDCCH monitoring occasion.

3. The method according to claim 2, wherein the physical slot comprises consecutive physical slots; or
the physical PDCCH monitoring occasion comprises consecutive physical PDCCH monitoring occasions.

4. The method according to claim 3, wherein the consecutive physical slots belong to a same search space, and the consecutive physical slots are physical slots in which PDCCH monitoring occasions are located; or the consecutive physical slots belong to multiple search spaces, and the consecutive physical slots are physical slots in which PDCCH monitoring occasions are located;
or
the consecutive physical PDCCH monitoring occasions belong to a same search space; or the consecutive physical PDCCH monitoring occasions belong to different search spaces.

5. The method according to claim 2, wherein the available slot meets at least one of the following:
in the available slot, a symbol on which the common PDCCH repetition transmission is located does not overlap a symbol on which a synchronization signal block (SSB) is located;
in the available slot, a symbol on which the common PDCCH repetition transmission is located does not overlap a symbol on which a physical random access channel (PRACH) is located;
in the available slot, a symbol on which the common PDCCH repetition transmission is located does not overlap a symbol on which a message A physical uplink shared channel (PUSCH) is located;
in the available slot, a symbol on which the common PDCCH repetition transmission is located does not overlap a symbol corresponding to another search space, wherein the another search space is different from a search space corresponding to the common PDCCH repetition transmission;
in the available slot, a symbol on which the common PDCCH repetition transmission is located does not overlap a symbol corresponding to another control resource set (CORESET), wherein the another CORESET is different from a CORESET corresponding to the common PDCCH repetition transmission;
in the available slot, a symbol on which the common PDCCH repetition transmission is located does not overlap a symbol on which another common PDCCH is located;
in the available slot, a symbol on which the common PDCCH repetition transmission is located is a downlink symbol; or
in the available slot, a symbol on which the common PDCCH repetition transmission is located is a flexible symbol.

6. The method according to claim 2, wherein the available PDCCH monitoring occasion meets at least one of the following:
a symbol corresponding to the available PDCCH monitoring occasion does not overlap a symbol on which an SSB is located;
a symbol corresponding to the available PDCCH monitoring occasion does not overlap a symbol on which a PRACH is located;
a symbol corresponding to the available PDCCH monitoring occasion does not overlap a symbol on which a message A PUSCH is located;
a symbol corresponding to the available PDCCH monitoring occasion does not overlap a symbol corresponding to another search space, wherein the another search space is different from a search space corresponding to the common PDCCH repetition transmission;
a symbol corresponding to the available PDCCH monitoring occasion does not overlap a symbol corresponding to another control resource set CORESET, wherein the another CORESET is different from a CORESET corresponding to the common PDCCH repetition transmission;
a symbol corresponding to the available PDCCH monitoring occasion does not overlap a symbol on which another common PDCCH is located;
a symbol corresponding to the available PDCCH monitoring occasion is a downlink symbol; or
a symbol corresponding to the available PDCCH monitoring occasion is a flexible symbol; and/or,
wherein in a case that the common PDCCH repetition transmission is an inter-slot repetition transmission, a count of a quantity of repetitions for the common PDCCH repetition transmission comprises at least one of the following:
a quantity of physical slots or a quantity of available slots;
or
in a case that the common PDCCH repetition transmission is an inter-occasion repetition transmission, a count of a quantity of repetitions for the common PDCCH repetition transmission comprises at least one of the following:
a quantity of physical PDCCH monitoring occasions or a quantity of available PDCCH monitoring occasions.

7. The method according to claim 1, further comprising:
in a case that the transmission resource comprises a collision slot in which the common PDCCH repetition transmission collides with another channel, performing first processing or second processing on the collision slot, wherein
the first processing comprises: discarding receiving of the common PDCCH repetition transmission in the collision slot; and
the second processing comprises: discarding receiving of the another channel in the collision slot.

8. The method according to claim 7, wherein the performing first processing or second processing on the collision slot comprises:
in a first case, performing the first processing on the collision slot, wherein the first case comprises at least one of the following:
the common PDCCH comprises a system information block (SIB1) PDCCH, or the another channel comprises an SSB;
the common PDCCH comprises a message 2 PDCCH, and the another channel comprises at least one of the following: an SSB, a SIB1 PDCCH, a SIB1 PDSCH, a PRACH, a message A PRACH, or a message A PUSCH;
the common PDCCH comprises a message 4 PDCCH or a message B PDCCH, and the another channel comprises at least one of the following: an SSB, a SIB1 PDCCH, a SIB1 PDSCH, a PRACH, a message A PRACH, a message A PUSCH, a message 2 PDCCH, a message 2 PDSCH, a message 3, or a PDCCH for scheduling a retransmission of a message 3;
the common PDCCH comprises a PDCCH for scheduling a retransmission of a message 3, and the another channel comprises at least one of the following: an SSB, a SIB1 PDCCH, a SIB1 PDSCH, a PRACH, a message A PRACH, a message A PUSCH, a message 2 PDCCH, a message 2 PDSCH, or a message 3; and
the common PDCCH comprises a paging PDCCH, and the another channel comprises at least one of the following: an SSB, a SIB1 PDCCH, a SIB1 PDSCH, a PRACH, a message A PRACH, a message A PUSCH, a message 2 PDCCH, a message 2 PDSCH, a message 3, a PDCCH for scheduling a retransmission of a message 3, a message 4 PDCCH, a message 4 PDSCH, or a physical uplink control channel (PUCCH) for hybrid automatic repeat request (HARQ) feedback of a message 4;
or
in a second case, performing the second processing on the collision slot, wherein the second case comprises at least one of the following:
the common PDCCH comprises a SIB1 PDCCH, and the another channel comprises at least one of the following: another PDCCH, a non-SIB1 PDSCH, a PRACH, or a common PUSCH; or
the common PDCCH comprises at least one of a message 2 PDCCH, a message 4 PDCCH, or a message B PDCCH, and the another channel comprises at least one of the following:
a PDCCH other than a SIB1 PDCCH;
a PDSCH other than a SIB1 PDSCH;
a common PUSCH; or
a dedicated PUCCH.

9. The method according to claim 7, wherein the performing first processing or second processing on the collision slot comprises:
performing the first processing or the second processing on the collision slot according to any one of the following rules:
prioritizing a 1^{st} transmission of the common PDCCH repetition transmission;
prioritizing transmission of a channel with a high priority; or
in a case of a same priority, prioritizing transmission of a channel with earlier generation time.

10. The method according to claim 1, wherein the transmission resource comprises at least one of the following indicated transmission resources:
a transmission resource indicated by system information;
a transmission resource indicated by an SSB;
a transmission resource indicated by a PDCCH resource configuration table;
a transmission resource indicated by a CORESET;
a transmission resource indicated by a search space;
a transmission resource indicated by a PDCCH monitoring occasion;
a transmission resource indicated by a PRACH resource;
a transmission resource indicated by a PRACH format; or
a transmission resource indicated by a repetition count type.

11. A method for sending a common physical downlink control channel (PDCCH), comprising:
determining, by a network side device, a transmission resource or a transmission characteristic of a common PDCCH repetition transmission; and
performing, by the network side device, the common PDCCH repetition transmission based on the transmission resource or the transmission characteristic, wherein the common PDCCH comprises at least one of the following:
a system information block (SIB1) PDCCH, an other system information (OSI) PDCCH, a message 2 PDCCH, a message 4 PDCCH, a message B PDCCH, a paging PDCCH, or a PDCCH for scheduling a retransmission of a message 3.

12. The method according to claim 11, wherein the transmission resource comprises at least one of the following:
a slot or a monitoring occasion, wherein
the slot comprises at least one of the following:
a physical slot or an available slot; and
the monitoring occasion comprises at least one of the following:
a physical PDCCH monitoring occasion or an available PDCCH monitoring occasion.

13. The method according to claim 11, further comprising:
in a case that the transmission resource comprises a collision slot in which the common PDCCH repetition transmission collides with another channel, performing first processing or second processing on the collision slot, wherein
the first processing comprises: discarding the common PDCCH repetition transmission in the collision slot; and
the second processing comprises: discarding the another channel in the collision slot.

14. The method according to claim 11, wherein the transmission resource comprises at least one of the following indicated transmission resources:
a transmission resource indicated by system information;
a transmission resource indicated by an SSB;
a transmission resource indicated by a PDCCH resource configuration table;
a transmission resource indicated by a CORESET;
a transmission resource indicated by a search space;
a transmission resource indicated by a PDCCH monitoring occasion;
a transmission resource indicated by a PRACH resource;
a transmission resource indicated by a PRACH format; or
a transmission resource indicated by a repetition count type.

15. A terminal, comprising a processor and a memory, wherein the memory stores a program or an instruction that is executable on the processor, wherein the program or the instruction, when executed by the processor, causes the terminal to perform:
determining a transmission resource or a transmission characteristic of a common PDCCH repetition transmission; and
receiving the common PDCCH repetition transmission based on the transmission resource or the transmission characteristic, wherein
the common PDCCH comprises at least one of the following:
a system information block (SIB1) PDCCH, an other system information (OSI) PDCCH, a message 2 PDCCH, a message 4 PDCCH, a message B PDCCH, a paging PDCCH, or a PDCCH for scheduling a retransmission of a message 3.

16. The terminal according to claim 15, wherein the transmission resource comprises at least one of the following:
a slot or a monitoring occasion, wherein
the slot comprises at least one of the following:
a physical slot or an available slot; and
the monitoring occasion comprises at least one of the following:
a physical PDCCH monitoring occasion or an available PDCCH monitoring occasion.

17. The terminal according to claim 16, wherein the physical slot comprises consecutive physical slots; or
the physical PDCCH monitoring occasion comprises consecutive physical PDCCH monitoring occasions.

18. The terminal according to claim 17, wherein the consecutive physical slots belong to a same search space, and the consecutive physical slots are physical slots in which PDCCH monitoring occasions are located; or the consecutive physical slots belong to multiple search spaces, and the consecutive physical slots are physical slots in which PDCCH monitoring occasions are located;
or
the consecutive physical PDCCH monitoring occasions belong to a same search space; or the consecutive physical PDCCH monitoring occasions belong to different search spaces.

19. The terminal according to claim 15, wherein the transmission resource comprises at least one of the following indicated transmission resources:
a transmission resource indicated by system information;
a transmission resource indicated by an SSB;
a transmission resource indicated by a PDCCH resource configuration table;
a transmission resource indicated by a CORESET;
a transmission resource indicated by a search space;
a transmission resource indicated by a PDCCH monitoring occasion;
a transmission resource indicated by a PRACH resource;
a transmission resource indicated by a PRACH format; or
a transmission resource indicated by a repetition count type.

20. A network side device, comprising a processor and a memory, wherein the memory stores a program or an instruction that is executable on the processor, and the program or the instruction is executed by the processor to implement the steps of the method for sending a common PDCCH according to claim 11.
